(19) United States
(12) Patent Application Publication
(10) Pub. No.: US 2025/0377869 A1
(43) Pub. Date: Dec. 11, 2025

(54) DATA-DRIVEN PLAYBOOK GENERATION

(71) Applicant: Cisco Technology, Inc., San Jose, CA (US)

(72) Inventor: Bernd M. Constant, Arlington, VA (US)

(21) Appl. No.: 19/232,732

(22) Filed: Jun. 9, 2025

Related U.S. Application Data
(60) Provisional application No. 63/658,284, filed on Jun. 10, 2024.

(51) Int. Cl. G06F 8/38; G06F 3/04842

(52) U.S. Cl. CPC G06F 8/38; G06F 3/04842

(57) ABSTRACT

Systems, methods, and computer-readable media may facilitate data-driven playbook generation. Resources may be sent to facilitate presentation of a graphical user interface (GUI) that allows configuring of function blocks with a playbook editor to build a playbook. The playbook editor may include an interface and a playbook canvas that allows addition and interrelation of function blocks to define an ordered set of operations to be performed in response to identification of an incident in an information technology (IT) environment. A selection of an interface option to add a first function block to the playbook canvas may be received. The first function block may be added to the playbook canvas of the interface. Outputs of the first function block with sample data for the outputs in a data panel of the interface may be presented in conjunction with the playbook canvas.

### CROSS-REFERENCE TO RELATED APPLICATION

This application claims benefit under 35 USC § 119 (e) to U.S. Provisional Patent Application No. 63/658,284, filed Jun. 10, 2024, and entitled “Data-Driven Playbook Generation,” the disclosure of which is incorporated by reference herein in its entirety for all purposes.

### BACKGROUND

Monitoring the operation and security of even a moderately complex computing environment typically involves a large number of tasks including, for example, investigating alerts generated by various operational and security monitoring applications, performing tasks to detect, triage, and respond to identified threats, and the like. To aid users and organizations with these and other tasks, some data intake and query systems provide users with a range of information technology (IT) and security-related applications (such as, e.g., security intelligence management services, Security Orchestration, Automation, and Response (SOAR) applications enterprise security applications, etc.). These applications broadly enable users to automatically monitor, detect, and investigate IT and security-related incidents, to automate repetitive tasks, and to strengthen defenses by connecting and coordinating complex workflows across security analyst teams and tools.

### BRIEF SUMMARY

Certain embodiments disclosed in the present disclosure relates to playbooks, and more particularly to systems, methods, and non-transitory, computer-readable media for data-driven playbook generation.

In one aspect, a computer-implemented method may include one or a combination of the following. Resources may be sent by an information technology (IT) and security operations application executing in a cloud provider network to facilitate presentation of a graphical user interface (GUI) that allows configuring of function blocks with a playbook editor to build a playbook. The playbook editor may include an interface. The interface may include a playbook canvas that allows addition and interrelation of function blocks to define an ordered set of operations to be performed in response to identification of an incident in an IT environment associated with a user. A selection of an interface option to add a first function block to the playbook canvas may be received. Responsive to the selection, the first function block may be added to the playbook canvas of the interface. Presentation, via the interface, of outputs of the first function block with sample data for the outputs in a data panel of the interface may be caused. The data panel may be presented in conjunction with the playbook canvas.

In another aspect, a system may include one or more processing devices to implement an IT and security operations application executing in a cloud provider network and cause the system to perform one or a combination of the following. Resources may be sent to facilitate presentation of a graphical user interface (GUI) that allows configuring of function blocks with a playbook editor to build a playbook. The playbook editor may include an interface. The interface may include a playbook canvas that allows addition and interrelation of function blocks to define an ordered set of operations to be performed in response to identification of an incident in an IT environment associated with a user. A selection of an interface option to add a first function block to the playbook canvas may be received. Responsive to the selection, the first function block may be added to the playbook canvas of the interface. Presentation, via the interface, of outputs of the first function block with sample data for the outputs in a data panel of the interface may be caused. The data panel may be presented in conjunction with the playbook canvas.

In yet another aspect, one or more non-transitory, computer-readable media may have stored thereon instructions which, when executed by one or more processors, cause a system in a cloud provider network to perform one or a combination of the following. Resources may be sent to facilitate presentation of a graphical user interface (GUI) that allows configuring of function blocks with a playbook editor to build a playbook. The playbook editor may include an interface. The interface may include a playbook canvas that allows addition and interrelation of function blocks to define an ordered set of operations to be performed in response to identification of an incident in an IT environment associated with a user. A selection of an interface option to add a first function block to the playbook canvas may be received. Responsive to the selection, the first function block may be added to the playbook canvas of the interface. Presentation, via the interface, of outputs of the first function block with sample data for the outputs in a data panel of the interface may be caused. The data panel may be presented in conjunction with the playbook canvas.

In various embodiments, the first function block may be executed with respect to the incident. Consequent to the execution, the data panel may be updated and caused to be presented with actual data associated with the incident and produced from the execution of the first function block. In various embodiments, the data panel may present a flow of the outputs of the first function block associated with the sample data as the playbook is being built. In various embodiments, one or more recommended actions as one or more candidates to be included within a second function block for the playbook may be generated as a function of a particular state of the data panel. The one or more recommended actions may be presenting via the interface. In various embodiments, a selection of a particular recommended action from the one or more recommended actions may be received. Responsive to the selection of the particular recommended action, the second function block corresponding to the particular recommended action may be added to the playbook canvas. In various embodiments, the adding the second function block may include connecting the second function block with a connector to the first function block. In various embodiments, the second function block may be added in a configured state with a corresponding field within the second function block prepopulated with corresponding data path from the first function block.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

Illustrative examples are described in detail below with reference to the following figures:

FIG. 1 is a block diagram of an example computing environment in which an IT and security operations application implements playbooks according to some examples.

FIG. 2 illustrates an example architecture for an IT and security operations application playbook execution engine according to some examples.

FIG. 3 illustrates a portion of an example graphical user interface (GUI) including a visual playbook editor (VPE) according to some examples.

FIG. 4 illustrates a portion of another example VPE interface according to some examples.

FIG. 5 illustrates a portion of an example data-based playbook generation and testing interface of the VPE interface according to some examples.

FIG. 6 is a flowchart illustrating an example process for data-driven playbook generation according to some examples.

FIG. 7 illustrates a portion of another example VPE interface according to some examples.

FIG. 8 illustrates how the VPE interface provides a block configuration panel to allow a user to configure a code block by selecting input parameters according to some examples.

FIG. 9 illustrates a data path selector data that may be exposed with a data preview panel according to some examples.

FIG. 10 illustrates a portion of the VPE interface to illustrate how the data preview panel may allow for a user to specify an incident according to some examples.

FIG. 11 illustrates an example of the data preview panel after a block has been selected from the container preview according to some examples.

FIG. 12 illustrates an example portion of the VPE interface after the action block has been added to the playbook canvas according to some examples.

FIG. 13 illustrates an example portion of the VPE interface after the action block has been saved and run according to some examples.

FIG. 14 illustrates an example portion of the VPE interface after the action block has been added according to some examples.

FIG. 15 is a block diagram illustrating in greater detail an example of an indexing system of a data intake and query system according to some examples.

FIG. 16 is a block diagram illustrating in greater detail an example of the search system of a data intake and query system according to some examples.

FIG. 17 is a block diagram illustrating an example computer system that may be used in some embodiments.

### DETAILED DESCRIPTION

The present disclosure relates to methods, apparatus, systems, and non-transitory, computer-readable storage media for data-driven playbook generation by an IT and security operations application.

Users of an IT and security operations application can create and execute playbooks to automate security and IT workflows, thereby improving the efficiency with which security teams can implement responses to incidents in IT environments. A user can define a playbook, for example, by linking together a series of actions that are provided by “apps”-software integrated with the IT and security operations application and used to interact with a device or service that is external to the IT and security operations application. The actions of a playbook are each implemented by computer program code, executed by the IT and operations application, responsive to the identification of an incident or by manual invocation by a user.

Typically, playbooks are not created all at one point in time. A playbook author may create a few blocks of the playbook, test these blocks, fix any issues, etc., and repeat this process over hours, days, or longer until it is believed to be satisfactory. Once the entire playbook is built, it may then be tested again before being used in a production environment.

As part of this process, when a playbook developer begins their work they may begin by considering an incident that they have solved or mitigated manually. For example, the developer may again look at the incident's artifacts (e.g., pieces of machine data that help indicate risk, such as data represented by risk objects, threat objects, assets, identities, indicators, etc.) and the automation history that the analyst may have run. This process may involve obtaining data from many different sources while simultaneously working with a playbook development editor interface to construct the new playbook, which is an arduous and challenging task.

For example, when starting work on a playbook a developer may want to begin by looking at artifact data, but they need to go obtain this data from another source. Further, the playbook editor may only provide recommendations not connected to their actual incident, which may or may not even include the artifact the developer wants to work with. In some cases, the playbook editor may not provide a useful recommendation of an artifact, and thus the developer may need to go to the incident they are working against, find their desired artifact name, go back to the playbook editor, have enough data path knowledge to craft an appropriate data path for the playbook, and pass that data path as a value in an action parameter. As the developer proceeds with this playbook development, because data may only be shown during action configuration, the developer cannot see all the incident or playbook data they need at once, which makes planning extremely difficult. Developers may then have to guess what to do next in the playbook because they do not know the current state of their data, and when they do know what block they want to add next, they may have to sort through hundreds or thousands of irrelevant apps and actions that are available.

Further, when developers are presented data in the playbook editor, it may be too much data, causing confusion and, ironically, leaving out some needed data. When such needed data is not displayed, the developer may have to add a debug block to the playbook editor canvas, save and run the playbook, open the debugger to review outputs, and repeat this process until they find the data path they are looking for. Overall, the user experience of such playbook editors can be challenging, as adding blocks to a playbook can be extremely labor-intensive, require many clicks, and be error prone.

In some examples, an IT and security operations application providers data-driven playbook testing and/or generation via allowing users to define and test playbook elements (such as blocks) through an examination and exploration of incident data. In some examples, users can explore a wide variety of actual data or metadata from actual incidents, such as involved network addresses, email addresses, categories, process names, annotations, system identifiers, dates, times, severity values, users, detected event or finding types, reputations, malware indicators, regions or locations, and/or many other types of metadata, to test and/or define processing blocks to be added to a playbook. In some examples, this actual data can be used with a candidate or “test” block operation and the result can be viewed and verified by the user before being added to a playbook. In some examples, the system can further suggest blocks or actions to be performed based on particular incident metadata elements of interest to the user or that exist within an incident under examination. For example, with a user selection of a representation of an IP address in the data, the system may suggest performing a geolocation of the address to identify a geographic location associated with the address, whereas with a user selection of a domain name in the data, the system may suggest performing a “whois” domain name lookup, etc.

Accordingly, in some examples, users of an IT and security operations application can create and test playbooks much easier utilizing intuitive at-a-glance data visualizations that show actual data in investigations. Additionally, in some examples, playbooks can be built much faster via system-recommended actions that the user can choose to incorporate in order to quickly add a correct action block to a playbook, potentially with a single click or user input. Moreover, in some examples, the system allows users to visualize results from individual playbook blocks to provide confidence that their desired action and outcome has been correctly captured.

Additionally, in some examples, a user can view real and explore data from their actual environment to assist them in defining playbooks that can be determined to accurately work on this actual data. In some examples, the system also provides suggested actions for playbook construction based on this data itself, such as actions commonly seen in playbooks (potentially across other customers, or from expert-provided recommendations) used for particular types of data. Accordingly, in some examples, the IT and security operations application provides a data-first playbook configuration flow enabling users to create playbooks while examining data, as opposed to focusing on logic and data paths.

Via use of examples disclosed herein, developers who may otherwise struggle with identifying and using incident artifacts in playbooks can instead easily select and utilize artifacts directly from a visual playbook editor (VPE) interface. When building a playbook, developers can quickly identify relevant artifacts, even ones bespoke to the particular user's operations, and incorporate these into playbooks without repeatedly having to reference back to the incident details.

Disclosed examples provide a clear and easy method to allow users to view and understand the data available while building a playbook. When entering a VPE, the developer can immediately see outputs from incidents and playbook blocks, allowing the developer to plan the structure of the playbook effectively by comprehending the data available at their disposal and identifying any dependencies that might affect the playbook's flow and functionality.

In some examples, developers can access or identify all necessary data paths while building their playbooks, via being provided a clear understanding and complete view of VPE block outputs, allowing for the efficient construction and refinement of playbooks without having to repeatedly use “debug” blocks in these playbooks.

Additionally, or alternatively, via intelligent suggestions provided by some examples, developers can add relevant actions to their playbooks without having to sift through an overwhelming number of options. Thus, developers can quickly identify and select actions that are pertinent to the specific tasks they are trying to automate. Moreover, examples can provide a straightforward way for developers to identify and select the correct data paths for their actions within a playbook, without needing extensive knowledge of data path syntax. Further, examples can provide a guided approach to developing playbooks for new users, enabling them to more easily understand the logic and flow of playbook development, thereby making it easier to learn and create effective automation workflows even with limited prior experience.

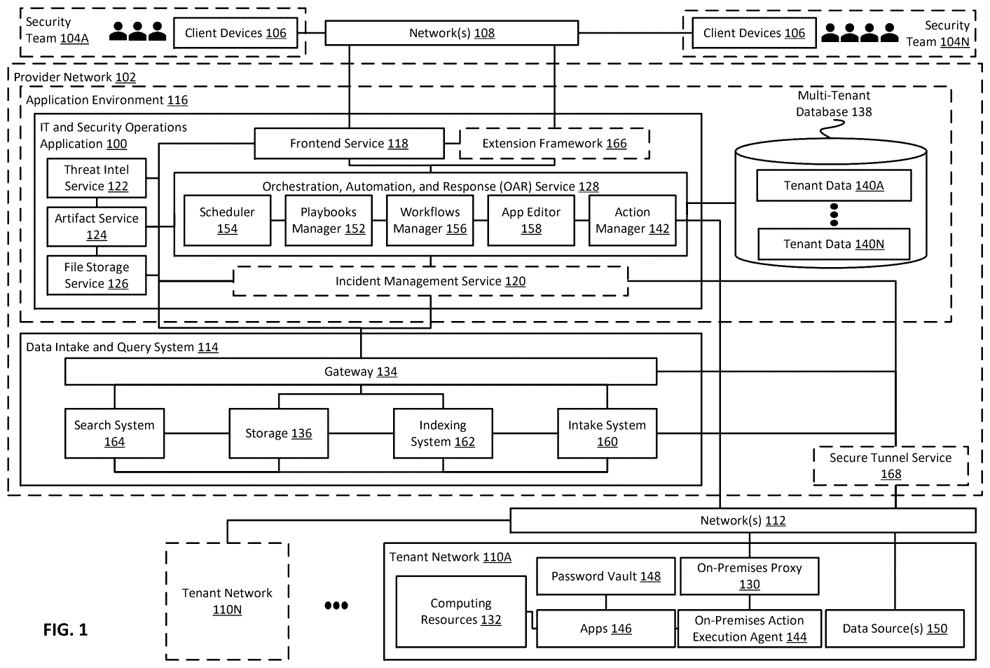

FIG. 1 is a block diagram of an example computing environment in which an IT and security operations application implements playbooks according to some examples. As shown in FIG. 1, an IT and security operations application 100 comprises software components executed by one or more electronic computing devices. In some examples, the computing devices are provided by a cloud provider network 102 (e.g., as part of a shared computing resource environment) while, in other examples, an IT and security operations application 100 executes on computing devices managed within an on-premises datacenter or other computing environment, or on computing devices located within a combination of cloud-based and on-premises computing environments.

The IT and security operations application 100 broadly enables users to perform security orchestration, automation, and response operations involving components of an organization's computing infrastructure (or components of multiple organizations' computing infrastructures). Among other benefits, an IT and security operations application 100 enables security teams and other users to automate repetitive tasks, to efficiently respond to security incidents and other operational issues, and to coordinate complex workflows across security teams and diverse IT environments. For example, users associated with various IT operations or security teams (sometimes referred to as “analysts,” where such analysts may be part of a security team 104A, . . . , security team 104N) can use client computing devices 106 to interact with the IT and security operations application 100 via one or more network(s) 108 to perform operations relative to IT environments for which they are responsible (such as, for example, one or more of tenant network 110A, . . . , tenant network 110N, which may be accessible over one or more intermediate network(s) 112, where network(s) 112 may be the same or different from network(s) 108). Although only two security teams are depicted in the example of FIG. 1, in general, any number of separate security teams can concurrently use an IT and security operations application 100 to manage any number of tenant networks, where each individual security team may be responsible for one or more tenant networks.

Users can interact with an IT and security operations application 100 and a data intake and query system 114 using client devices 106. The client devices 106 can communicate with the IT and security operations application 100 and with data intake and query system 114 in a variety of ways such as, for example, over an internet protocol via a web browser or other application, via a command line interface, via a software developer kit (SDK), and the like. In some examples, the client devices 106 can use one or more executable applications or programs from an application environment 116 to interface with the data intake and query system 114, such as the IT and security operations application 100. The application environment 116 can include, for example, tools, software modules (e.g., computer executable instructions to perform a particular function), etc., that enable application developers to create computer executable applications to interface with an IT and security operations application 100 and/or data intake and query system 114. The IT and security operations application 100, for example, can use aspects of the application environment 116 to interface with the data intake and query system 114 to obtain relevant data, process the data, and display it in a manner relevant to the IT operations and security context. As shown, the IT and security operations application 100 further includes additional backend services, middleware logic, front-end user interfaces, data stores, and other computing resources, and provides other facilities for ingesting use case specific data and interacting with that data, as described elsewhere herein.

As an example of using the application environment 116, the IT and security operations application 100 includes custom web-based interfaces (e.g., provided at least in part by a frontend service 118) that optionally rely on one or more user interface components and frameworks provided by the application environment 116. In some examples, an IT and security operations application 100 includes, for example, a “mission control” interface or set of interfaces. In this context, a mission control interface refers to any type of interface or set of interfaces that broadly enable users to obtain information about their IT environments, to configure automated actions, playbooks, etc., and to perform operations related to IT and security infrastructure management. The IT and security operations application 100 further includes middleware business logic (including, for example, an optional incident management service 120, a threat intelligence service 122, an artifact service 124, a file storage service 126, and an orchestration, automation, and response (OAR) service 128) implemented on a middleware platform of developers' choice. Furthermore, in some examples, an IT and security operations application 100 can be instantiated and executed in a different isolated execution environment relative to the data intake and query system 114. As a non-limiting example, in cases where the data intake and query system 114 is implemented at least in part in a Kubernetes cluster, the IT and security operations application 100 can execute in a different Kubernetes cluster (or other isolated execution environment system) and interact with the data intake and query system 114 via the gateway 134.

In examples where an IT and security operations application 100 is deployed in a tenant network, the application can instead be deployed as a virtual appliance at one or more computing devices managed by an organization using the IT and security operations application 100. A virtual appliance, for example, can include a VM image file that is pre-configured to run on a hypervisor or directly on the hardware of a computing device and that includes a pre-configured operating system upon which the IT and security operations application 100 executes. In other examples, the IT and security operations application 100 can be provided and installed using other types of standalone software installation packages or software package management systems. Depending on the implementation and user preference, an IT and security operations application 100 optionally can be configured on a standalone server or in a clustered configuration across multiple separate computing devices.

A user can initially configure an IT and security operations application 100 using a web-based console or other interface provided by the IT and security operations application 100 (for example, as provided by a frontend service 118 of the IT and security operations application 100). For example, users can use a web browser or other application to navigate to the IP address or hostname associated with the IT and security operations application 100 to access console interfaces, dashboards, and other interfaces used to interact with various aspects of the application. The initial configuration can include creating and configuring user accounts, configuring connection settings to one or more tenant networks (for example, including settings associated with one or more on-premises proxies 130 used to establish connections between on-premises networks and the IT and security operations application 100 running in a provider network 102 or elsewhere), and performing other optional configurations.

A user (also referred to herein as a “customer,” “tenant,” or “analyst”) of an IT and security operations application 100 can create one or more user accounts to be used by a security team or other users associated with the user. A user of the IT and security operations application 100, for example, typically desires to use the application to manage one or more tenant networks for which the user is responsible (illustrated by example tenant networks 110A, . . . , 110N in FIG. 1). A tenant network can include any number of computing resources 132 operating as part of a corporate network or other networked computing environment with which a user is associated. Although the tenant networks 110A, . . . , 110N are shown as separate from the provider network 102 in FIG. 1, more generally, a tenant network can include components hosted in an on-premises network, in a provider network 102, or combinations of both (for example, as a hybrid cloud network).

In general, any of the computing resources 132 in a tenant network can potentially serve as a source of incident data to an IT and security operations application 100, a computing resource against which actions can be performed by the IT and security operations application 100, or both. The computing resources 132 can include various types of computing devices, software applications, and services including, but not limited to, a data intake and query system 114 (which itself can ingest and process machine data generated by other computing resources 132), a security information and event management (SIEM) system, a representational state transfer (REST) client that obtains or generates incident data based on the activity of other computing resources 132, software applications (including operating systems, databases, web servers, etc.), routers, intrusion detection systems and intrusion prevention systems (IDS/IDP), client devices (for example, servers, desktop computers, laptops, tablets, etc.), firewalls, and switches. The computing resources 132 can execute upon any number separate computing devices and systems within a tenant network.

During operation, data intake and query systems, SIEM systems, REST clients, and other system components of a tenant network obtain operational, performance, and security data from computing resources 132 in the network, analyze the data, and may identify potential IT and security-related incidents from time to time. A data intake and query system in a tenant network, for example, might identify potential IT-related incidents based on the execution of correlation searches against data ingested and indexed by the system, as described elsewhere herein. Other data sources 150 can obtain incident and security-related data using other processes. Once obtained, data indicating such incidents is sent to the data intake and query system 114 or IT and security operations application 100 via an on-premises proxy 130. For example, once a data intake and query system identifies a possible security threat or other IT-related incident based on data ingested by the data intake and query system, data representing the incident can be sent to the data intake and query system 114 via a REST application programming interface (API) endpoint implemented by a gateway 134 or a similar gateway of the IT and security operations application 100. As mentioned elsewhere herein, a data intake and query system 114 or IT and security operations application 100 can ingest, index, and store data received from each tenant network in association with a corresponding tenant identifier such that each tenant's data is segregated from other tenant data (for example, when stored in common storage 136 of the data intake and query system 114 or in a multi-tenant database 138 of the IT and security operations application 100).

As mentioned, in some examples, some or all of the data ingested and created by an IT and security operations application 100 in association with a particular tenant is generally maintained separately from other tenants (for example, as illustrated by tenant data 140A, . . . , tenant data 140N in the multi-tenant database 138). In some examples, a tenant may further desire to keep data associated with two or more separate tenant networks segregated from one another. For example, a security team associated with a managed security service provider (MSSP) may be responsible for managing any number of separate tenant networks for various customers of the MSSP. As another example, a tenant corresponding to a business organization having large, separate departments or divisions may desire to logically isolate the data associated with each division. In such instances, a tenant can configure separate “departments” in the IT and security operations application 100, where each department is associated with a respective tenant network or other defined collection of data sources, computing resources, and so forth. Users and user teams can thus use this feature to manage multiple third-party entities or organizations using only a single login and permissions configuration for the IT and security operations application 100.

Once an IT and security operations application 100 obtains incident data, either directly from a tenant network or indirectly via a data intake and query system 114, the IT and security operations application 100 analyzes the incident data and enables users to investigate, determine possible remediation actions, and perform other operations. These actions can include default actions initiated and performed within a tenant network without direct interaction from user and can further include suggested actions provided to users associated with the relevant tenant networks. Once the suggested actions are determined, these actions can be presented in a “mission control” dashboard or other interface accessible to users of the IT and security operations application 100. Based on the suggested actions, a user can select one or more particular actions to be performed and the IT and security operations application 100 can carry out the selected actions within the corresponding tenant network. In the example of FIG. 1, an OAR service 128 of the IT and security operations application 100, which includes an action manager 142, can cause actions to be performed in a tenant network by sending action requests via network 112 to an on-premises proxy 130, which further interfaces with an on-premises action execution agent (for example, on-premises action execution agent 144 in tenant network 110A). In this example, the on-premises action execution agent 144 is implemented to receive action requests from an action manager 142 and to carry out requested actions against computing resources 132 using apps 146 (sometimes alternatively referred to as “connectors”) and optionally a password vault 148 (e.g., to authenticate an app to one or more computing resources 132).

To execute actions against computing resources in tenant networks and elsewhere, in some examples, an IT and security operations application 100 uses a unified security language that includes commands usable across a variety of hardware and software products, applications, and services. To execute a command specified using the unified security language, in some examples, the IT and security operations application 100 (possibly via an on-premises action execution agent 144) uses one or more apps 146 to translate the commands into the one or more processes, languages, scripts, etc., necessary to implement the action at one or more particular computing resources 132. For example, a user might provide input requesting the IT and security operations application 100 to remove an identified malicious process from multiple computing systems in the tenant network 110A, where two or more of the computing systems are associated with different software configurations (for example, different operating systems or operating system versions). Accordingly, in some examples, the IT and security operations application 100 can send an action request to an on-premises action execution agent 144, which then uses one or more apps 146 to translate the command into the necessary processes to remove each instance of the malicious process on the varying computing systems within the tenant network (including the possible use of credentials and other information stored in the password vault 148).

In some examples, an IT and security operations application 100 includes a playbooks manager 152 that enables users to automate actions or series of actions by creating digital “playbooks” that can be executed by the IT and security operations application 100. At a high level, a playbook represents a customizable computer program that can be executed by an IT and security operations application 100 to automate a wide variety of possible operations related to an IT environment. These operations—such as quarantining devices, modifying firewall settings, restarting servers, and so forth—are typically performed by various security products by abstracting product capabilities using an integrated “app model.” Additional details related to operation of the IT and security operations application 100 and use of digital playbooks are provided elsewhere herein.

In some examples, an IT and security operations application 100 can support both automation playbooks and input playbooks. An automation playbook can be created and used, for example, to run automatically based on triggers. In some examples, an input playbook accepts configured inputs to run, provides configured outputs, and can be used as a sub-playbook of another automation or input playbook. In other examples, any type of playbook can be used as an automation playbook or input playbook (e.g., an IT and security operations application 100 need not make a distinction between the two).

As mentioned, an IT and security operations application 100 may be implemented as a collection of interworking services that each carry out various functionality as described herein. In the example shown in FIG. 1, the IT and security operations application 100 includes an incident management service 120, a frontend service 118, an artifact service 124, a threat intelligence service 122, a file storage service 126, and an orchestration, automation, and response (OAR) service 128. The set of services comprising the IT and security operations application 100 in FIG. 1 are provided for illustrative purposes only; in other examples, an IT and security operations application 100 can be comprised of more or fewer services and each service may implement the functionality of one or more of the services shown.

In some examples, an incident management service 120 is responsible for obtaining incidents or events (sometimes also referred to as “notables”), either directly from various data sources 150 in tenant networks or directly based on data ingested by the data intake and query system 114 via the gateway 134. The frontend service 118 provides user interfaces to users of the application, among other processes described herein. Using these user interfaces, users of the IT and security operations application 100 can perform various application-related operations, view displays of incident-related information, and can configure administrative settings, license management, content management settings, and so forth. In some examples, an artifact service 124 manages artifacts associated with incidents received by the application, where incident artifacts can include information such as IP addresses, usernames, file hashes, and so forth. In some examples, a threat intelligence service 122 obtains data from external or internal sources to enable other services to perform various incident data enrichment operations. As one non-limiting example, if an incident is associated with a file hash, a threat intelligence service 122 can be used to correlate the file hash with external threat feeds to determine whether the file hash has been previously identified as malicious. In some examples, a file storage service 126 enables other services to store incident-related files, such as email attachments, files, and so forth. In some examples, an OAR service 128 performs a wide range of OAR capabilities such as action execution (via an action manager 142), playbook execution (via a playbooks manager 152), scheduling work to be performed (via a scheduler 154), user approvals and so forth as workflows (via a workflows manager 156), among other functionality described herein. According to examples described herein, an OAR service 128 includes an app editor 158 that enables users to create, modify, and test apps (e.g., including apps 146 utilized within a local tenant network, apps used by an IT and security operations application 100 running in a provider network 102, or used elsewhere) using the built-in app editor, as described in more detail herein.

The operation of an IT and security operations application 100 generally begins with the ingestion of data related to various types of incidents involving computing resources of various tenant networks (for example, computing resources 132 or other data sources 150 of a tenant network 110A). In some examples, users configure an IT and security operations application 100 to obtain, or “ingest,” data from one or more defined data sources 150, where such data sources can be any type of computing device, application, or service that supplies information that users may want to store or act upon, and where such data sources may include one or more of the computing resources 132 or data sources which generate data based on the activity of one or more computing resources 132. As mentioned, examples of data sources include, but are not limited to, a data intake and query system such as the SPLUNK® ENTERPRISE system, a SIEM system, a REST client, applications, routers, intrusion detection systems (IDS)/intrusion prevention systems (IDP) systems, client devices, firewalls, switches, or any other source of data identifying potential incidents in tenants' IT environments. Some of these data sources may themselves collect and process data from various other data generating components such as, for example, web servers, application servers, databases, firewalls, routers, operating systems, and software applications that execute on computer systems, mobile devices, sensors, Internet of Things (IoT) devices, etc. The data generated by the various data sources can be represented in any of a variety of data formats.

In some examples, data can be sent from tenant networks to an IT and security operations application 100 using any of several different mechanisms. As one example, data can be sent to data intake and query system 114, processed by an intake system 160 (e.g., including indexing of resulting event data by an indexing system 162, thereby further causing the event data to be accessible to a search system 164), and obtained by an incident management service 120 of the IT and security operations application 100 via a gateway 134. As another example, components can send data from a tenant network directly to the incident management service 120, for example, via a REST endpoint.

In some examples, data ingested by an IT and security operations application 100 from configured data sources 150 can be represented in the IT and security operations application 100 by data structures referred to as “incidents, “events,” “notables,” or “containers”. Here, an incident or event is a structured data representation of data ingested from a data source and that can be used throughout the IT and security operations application 100. In some examples, an IT and security operations application 100 can be configured to create and recognize different types of incidents depending on the corresponding type of data ingested, such as “IT incidents” for IT operations-related incidents, “security incidents” for security-related incidents, and so forth. An incident can further include any number of associated events and “artifacts,” where each event or artifact represents an item of data associated with the incident. As a non-limiting example, an incident used to represent data ingested from an anti-virus service and representing a security-related incident might include an event indicating the occurrence of the incident and associated artifacts indicating a name of the virus, a hash value of a file associated with the virus, a file path on the infected endpoint, and so forth.

An incident of an IT and security operations application 100 can be associated with a status or state that may change over time. Analysts and other users can use this status information, for example, to indicate to other analysts which incidents an analyst is actively investigating, which incidents have been closed or resolved, which incidents are awaiting input or action, and the like. Furthermore, an IT and security operations application 100 can use the transitions of incidents from one status to another to generate various metrics related to analyst efficiency and other measurements of analyst teams. For example, the IT and security operations application 100 can be configured with a number of default statuses, such as “new” or “unknown” to indicate incidents that have not yet been analyzed, “in progress” for incidents that have been assigned to an analyst and are under investigation, “pending” for incidents that are waiting input or action from an analyst, and “resolved” for incidents that have been addressed by an assigned analyst. An amount of time that elapses between these statuses for a given incident can be used to calculate various measures of analyst and analyst team efficiency, such as measurements of a mean time to resolve incidents, a mean time to respond to incidents, a mean time to detect an incident that is a “true positive,” a mean dwell time reflecting an amount of time taken to identify and remove threats from an IT environment, among other possible measures. Analyst teams can also create custom statuses to indicate incident states that may be more specific to the way the particular analyst team operates, and further create custom efficiency measurements based on such custom statuses.

In some examples, an IT and security operations application 100 also generates and stores data related to its operation and activity conducted by tenant users including, for example, playbook data, workbook data, user account settings, configuration data, and historical data (such as, for example, data indicating actions taken by users relative to particular incidents or artifacts, data indicating responses from computing resources based on action executions, and so forth), in one or more multi-tenant databases 138. In other examples, some or all the data above is stored in storage managed by the data intake and query system 114 and accessed via the gateway 134. These multi-tenant database(s) 138 can operate on a same computer system as the IT and security operations application 100 or at one or more separate database instances. As mentioned, in some examples, the storage of such data by the data intake and query system 114 and IT and security operations application 100 for each tenant is generally segregated from data associated with other tenants based on tenant identifiers stored with the data or other access control mechanisms.

An IT and security operations application 100 can define and implement many different types of “actions,” which represent high-level, vendor- and product-agnostic primitives that can be used throughout the IT and security operations application 100. Actions generally represent simple and user-friendly verbs that are used to execute actions in playbooks or manually through other user interfaces of the IT and security operations application 100, where such actions can be performed against one or more computing resources in an IT environment. In many cases, a same action defined by the IT and security operations application 100 can be carried out on computing resources associated with different vendors or configurations via action translation processes performed by apps of the platform, as described in more detail elsewhere herein. Examples of actions that can be defined by an IT and security operations application 100 include a “get process dump” action, a “block IP address” action, a “suspend VM” action, a “terminate process” action, and so forth.

In some examples, an IT and security operations application 100 enables connectivity with various IT computing resources in a provider network 102 and in tenant networks 110A, . . . , 110N, including IT computing resources from a wide variety of third-party IT and security technologies, and further enables the ability to execute actions against those computing resources via apps (such as the apps 146 in tenant network 110A and apps implemented as part of the IT and security operations application 100). In general, an app 146 represents program code that provides an abstraction layer (for example, via one or more libraries, APIs, or other interfaces) to one or more of hundreds of possible IT and security-related products and services and which exposes lists of actions supported by those products and services. Each app 146 can also define which types of computing resources that the app can operate on, an entity that created the app, among other information.

As one example, an IT and security operations application 100 can be configured with an app 146 that enables the application 100 to communicate with a VM product provided by a third-party vendor. In this example, the app for the VM product enables the IT and security operations application 100 to take actions relative to VM instances within a user's IT environment, including starting and stopping the VMs, taking VM snapshots, analyzing snapshots, and so forth. To enable the app 146 to communicate with a VM manager or with individual VM instances, the app 146 can be configured with login credentials, hostnames or IP addresses, and so forth, for each instance with which communication is desired (or the app may be configured to obtain such information from a password vault 148). Other apps 146 can be created and made available for VM products from other third-party vendors, where those apps may be configured to translate some or all the same actions that are available with respect to the first type of VM product. In general, apps 146 enable interaction with virtually any type of computing resource 132 in an IT environment and can be added and updated over time to support new types of computing resources. Additional details related to the creation and modification of apps is described elsewhere herein.

In some examples, computing resources 132 can include physical or virtual components within an organization with which an IT and security operations application 100 communicates (for example, via apps as described above). Examples of computing resources 132 include, but are not limited to, servers, endpoint devices, applications, services, routers, and firewalls. A computing resource 132 can be represented in an IT and security operations application 100 by data identifying the computing resource, including information used to communicate with the device or service such as, for example, an IP address, automation service account, username, password, etc. In some examples, one or more computing resources 132 can be configured as a source of incident information that is ingested by an IT and security operations application 100. The types of computing resources 132 that can be configured in the IT and security operations application 100 may be determined in some cases based on which apps 146 are installed for a particular user. In some examples, automated actions can be configured with respect to various computing resources 132 using playbooks, described in more detail elsewhere herein. Each computing resource 132 may be hosted in an on-premises tenant network, a cloud-based provider network, or any other network or combination thereof.

The operation of an IT and security operations application 100 can include the ability to create and execute customizable playbooks. At a high level, a playbook comprises computer program code and possibly other data that can be executed by an IT and security operations application 100 to carry out an automated set of actions (for example, as managed by a playbooks manager 152 as part of the OAR service 128). In some examples, a playbook is comprised of one or more functions, or codeblocks or function blocks, where each function contains program code that performs defined functionality when the function is encountered during execution of the playbook of which it is a part. As an example, a first function block of a playbook might implement an action that upon execution affects one or more computing resources 132 (e.g., by configuring a network setting, restarting a server, etc.); another function block might filter data generated by the first function block in some manner; yet another function block might obtain information from an external service, and so forth. A playbook is further associated with a control flow that defines an order in which the IT and security operations application 100 executes the function blocks of the playbook, where a control flow may vary at each execution of a playbook depending on particular input conditions (e.g., where the input conditions may derive from attributes associated with an incident triggering execution of the playbook or based on other accessible values).

In some examples, the IT and security operations application 100 described herein provides a visual playbook editor (VPE)—for example, as an interface provided by a frontend service 118—that allows users to visually create and modify playbooks. Using a VPE GUI, for example, users can codify a playbook by creating and manipulating a displayed graph including nodes and edges, where each of the nodes in the graph represents one or more function blocks that each perform one or more defined operations during execution of the playbook, and where the edges represent a control flow among the playbook's function blocks. In this manner, users can craft playbooks that perform complex sequences of operations without having to write some or any of the underlying code. The VPE interfaces further enable users to supplement or modify the automatically generated code by editing the code associated with a visually designed playbook, as desired.

An IT and security operations application 100 can provide one or more playbook management interfaces that enable users to locate and organize playbooks associated with a user's account. A playbook management interface can display a list of playbooks that are associated with a user's account and further provide information about each playbook such as, for example, a name of the playbook, a description of the playbook's operation, a number of times the playbook has been executed, a last time the playbook was executed, a last time the playbook was updated, tags or labels associated with the playbook, a repository at which the playbook and the associated program code is stored, a status of the playbook, and the like.

Users can create a new digital playbook starting from a playbook management interface or using another interface provided by the IT and security operations application 100. Using a playbook management interface, for example, a user can select a “create new playbook” interface element and the IT and security operations application 100 causes display of a VPE interface including a graphical canvas on which users can add nodes representing operations to be performed during execution of the playbook, where the operations are implemented by associated source code that can be automatically generated by the VPE, and add connections or edges among the nodes defining an order in which the represented operations are to be performed upon execution.

In some examples, the creation of a graph representing a playbook includes the creation of connections between function blocks, where the connections are represented by edges that visually connect the nodes of the graph representing the collection of function blocks. These connections among the playbook function blocks indicate a program flow for the playbook, defining an order in which the operations specified by the playbook blocks are to occur. For example, if a user creates a connection that links the output of a block A to the input of a block B, then block A executes to completion before execution of block B begins during execution of the playbook. In this manner, output variables generated by the execution of block A can be used by block B (and any other subsequently executed blocks) during playbook execution.

Once a user has codified a playbook using a VPE or other interface, the playbook can be saved (for example, in a multi-tenant database 138 and in association with one or more user accounts) and run by the IT and security operations application 100 on-demand. As illustrated in the example playbooks above, a playbook includes a “start” block that is associated with source code that begins execution of the playbook. More particularly, the IT and security operations application 100 executes the function represented by the start block for a playbook with container context comprising data about the incident against which the playbook is executed, where the container context may be derived from input data from one or more configured data sources. A playbook can be executed manually in response to a user providing input requesting execution of the playbook, or playbooks can be executed automatically in response to the IT and security operations application 100 obtaining input events matching certain criteria. In examples where the source code associated with a playbook is based on an interpreted programming language (for example, such as the Python programming language), the IT and security operations application 100 can execute the source code represented by the playbook using an interpreter and without compiling the source code into compiled code. In other examples, the source code associated with a playbook can first be compiled into byte code or machine code the execution of which can be invoked by the IT and security operations application 100.

In some examples, an optional IT and security operations application extension framework 166 allows users to extend the user interfaces, data content, and functionality of an IT and security operations application 100 in various ways to enhance and enrich users' workflow and investigative experiences. Example types of extensions enabled by the extension framework 166 include modifying or supplementing GUI elements (including, e.g., tabs, menu items, tables, dashboards, visualizations, etc.) and other components (including, e.g., response templates, connectors, playbooks, etc.), where users can implement these extensions at pre-defined extension points of the IT and security operations application 100. In some examples, the extension framework 166 further includes a data integration system that provides users with mechanisms to integrate data from external applications, services, or other data sources into their plugins (e.g., to visualize data from any external data source in the IT and security operations application 100 or to otherwise enhance users' investigative experience with data originating outside of the IT and security operations application or data intake and query system 114).

The types of users that might be interested in creating plugins using an IT and security operations application extension framework 166 include, for example, development teams associated with a data intake and query system 114, developers of third-party applications or services relevant to the IT and security operations application 100 (e.g., developers of VM management software, cloud computing resource management software, etc.), and other general users of the IT and security operations application 100. Users of the IT and security operations application 100 might, for example, desire to enhance their own workflows and other processes by enabling internal user information lookups, creating internal ticketing system postings, or enabling any other desired visualizations or actions at various points in the IT and security operations application. In some examples, the extension framework 166 enables users to create plugins using “No-Code” development tools, e.g., where users can define the specifications for custom visualizations, data integrations, and other plugin components without direct user coding (e.g., without the direct creation of JavaScript code, JSON specifications, or other data comprising a plugin), although users can also modify the underlying plugin components as desired.

As one example use case for a plugin, consider a cybersecurity company that provides security software that is known to be used by users of the IT and security operations application 100. In this example, developers of the security software might desire for certain information collected or generated by the security software to be visible at various points within the IT and security operations application 100, e.g., to create a tighter integration of the two software applications. The developers, for example, might desire for users of the IT and security operations application 100 to be able to view endpoint information, malware information, etc., collected by the security application when users view various visualizations or other incident information in the IT and security operations application 100 that is associated with the data collected by the security software.

In the example above, developers associated with the cybersecurity company can use the extension framework 166 to create a plugin that integrates the data collected by the security application with the IT and security operations application 100. Users who subscribe to the plugin can then view relevant data or perform other actions when the users navigate to defined extension points of the IT and security operations application 100. Numerous other such use cases exist for a wide variety of applications, data sources, and desired functionality related to an IT and security operations application 100. Among other benefits, the ability to create and use plugins to an IT and security operations application 100 enables security teams to efficiently investigate and remediate a wide variety of incidents that occur from time to time in IT environments, thereby improving the overall security and operation of the IT environments.

In some examples, components external to the IT and security operations application 100 interface with an intermediary secure tunnel service 168 to send communications to, and to receive communications from, an IT and security operations application 100 running in a provider network 102. In some examples, the secure tunnel service 168 operates as a service that establishes WebSocket or other types of secure connections to endpoint devices. As one example, the secure tunnel service 168 can establish a first secure connection to the IT and security operations application 100 and a second secure connection to an on-premises proxy 130 and an on-premises action execution agent 144 executing in a tenant network 110A, where each connection is established using a handshake technique with the respective endpoints. Once established, the connection enables two-way communications between the IT and security operations application 100 (e.g., via a separate proxy implemented by the IT and security operations application 100) and the on-premises action execution agent 144 without the need to open a port in a firewall or perform other configurations to a network associated with the tenant network 110A. In some examples, the secure tunnel service 168 is a cloud-based service (e.g., executing using computing resources provided by a provider network 102) configured to transfer data between an IT and security operations application 100 and computing devices located on networks external to the provider network 102, including on-premises action execution agents, mobile devices, and the like. In other examples, the secure tunnel service 168 executes using computing resources located outside of a cloud-based environment.

In some examples, the secure tunnel service 168 performs authentication operations with other components (e.g., the IT and security operations application 100 and an on-premises proxy 130 or on-premises action execution agent 144) to establish trust and then establishes secure communications channels with those components, where the secure tunnel service 168 and other components transmit secure communications using the secure communications channels. In some examples, the secure tunnel service 168 provides end-to-end encryption (E2EE) of communications between the IT and security operations application 100 and an on-premises action execution agent 144 via an on-premises proxy 130 by transmitting one or more encrypted data packets between the IT and security operations application 100 and the on-premises proxy 130. In some examples, communications sent through the secure tunnel service 168 are in the form of data packets, where each data packet includes, for example, a payload and a device identifier for a destination device that is to receive the data packet. In other examples, the data packet can also include a device identifier for the source device or an instance identifier that indicates an IT and security operations application instance associated with the data packet. In some examples, the data packet is encrypted prior to being transmitted to the secure tunnel service 168, e.g., using a public key of an asymmetric key pair generated by a receiving device. While in some examples, the secure tunnel service 168 decrypts the data packet before sending the data packet to its intended destination, in other examples, the secure tunnel service 168 forwards the encrypted data packet to its intended destination without performing a decryption process.

The IT and security operations application 100 and on-premises proxy 130 can communicate with the secure tunnel service 168 across network(s) 112. As indicated herein, the networks 112 can be communications networks, such as a local area network (LAN), wide area network (WAN), cellular network (e.g., LTE, HSPA, 3G, 4G, and/or any other network based on cellular technologies), and/or networks using any of wired, wireless, terrestrial microwave, or satellite links. In some examples, after an on-premises action execution agent 144 is installed and executed within a tenant network 110A, the on-premises action execution agent 144 uses an on-premises proxy 130 to initiate a process to establish a secure connection (e.g., a gRPC Remote Procedure Calls (gRPC) over HTTP/2 connection) with a secure tunnel service 168. For example, the secure tunnel service 168 may establish the secure connection and associate the secure connection with a device identifier for the on-premises proxy 130.

In some examples, the secure tunnel service 168 maintains a database that stores document data structures and optionally stores keys. This database, for example, can be a structure query language (SQL) database, or a NoSQL database, such as an AMAZON® DynamoDB. In some examples, the database includes a key store that stores encryption keys, including single-use session keys and long-term keys associated with devices that send E2EE communications. In other examples, the secure tunnel service 168 does not store encryption keys and routes messages without the use of a key store. In some examples, the database also includes a routing table that includes address information associated with devices registered with the secure tunnel service 168 with which the service has established secure communications. The secure tunnel service 168, for example, can send queries to the database to determine, based on a device identifier in a particular data packet, the address of the intended recipient of the particular data packet.

As illustrated in FIG. 1, the secure tunnel service 168 may not directly communicate with an on-premises action execution agent 144 but communicate instead through an on-premises proxy 130. As indicated herein, the on-premises proxy 130 is a process executing in the tenant network 110A and that operates as a gateway between the secure tunnel service 168 and the IT and security operations application 100. The on-premises proxy 130 is configured to receive messages from the secure tunnel service 168 and forward the messages to the on-premises action execution agent 144 for processing. The on-premises proxy 130 can also be configured to generate and send messages (e.g., notifications, alerts, etc.) IT and security operations application 100 via the secure tunnel service 168. In some examples, the on-premises proxy 130 can also send messages to configured mobile devices in accordance with a push notification service, such as the APPLE® Push Notification service (APN), or GOOGLE® Cloud Messaging (GCM). In some examples, the on-premises proxy 130 is configured to perform the management, generation, and registration of encryption keys used to communicate with the secure tunnel service 168.

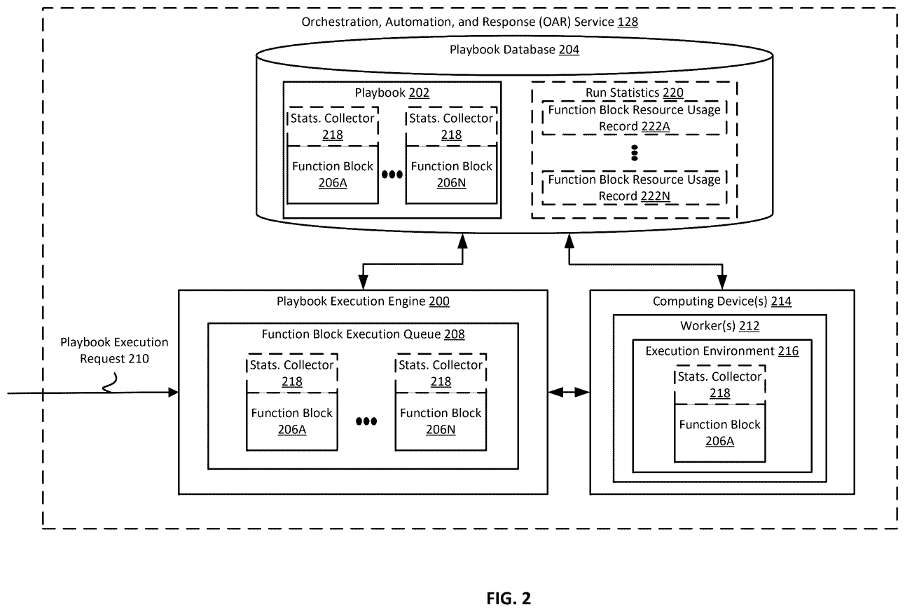

FIG. 2 illustrates an example architecture for an IT and security operations application playbook execution engine according to some examples. As shown, the playbook execution engine 200 (which may be part of the OAR service 128 or any other component of an IT and security operations application 100) executes playbooks from time to time (such as an example playbook 202 stored in a playbook database 204). As described in more detail hereinafter, execution of a playbook generally involves the playbook execution engine 200 executing the function blocks of the playbook in an order defined by a control flow associated with the playbook (and possibly further based on a container context comprising data about an incident associated with the execution of the playbook). In some examples, the execution of a playbook can further include the collection of run statistics associated with the execution of the individual function blocks that are part of a playbook.

For example, a playbook 202 can include any number of function blocks 206A, . . . , through function block 206N. Some of the function blocks of playbook 202 may be a same, reusable function block that can be used across any number of playbooks (e.g., template function blocks provided by the IT and security operations application 100), while other function blocks may represent custom code function blocks developed by individual users of the IT and security operations application. A playbook can be executed manually responsive to a user requesting execution of the playbook, or a playbook can be executed automatically responsive to an IT and security operations application 100 identifying one or more incidents matching certain triggering criteria associated with the playbook. In general, each playbook can include any number and combination of function blocks depending on the desired functionality to be implemented by the playbook. While only one playbook is shown in FIG. 2, in general, an IT and security operations application 100 can be associated with any number of distinct playbooks associated with any number of separate users or tenants of the application. Furthermore, at any given time, a playbook execution engine 200 can receive any number of concurrent or overlapping requests to execute a same playbooks or different playbooks.

In some examples, to manage the execution of requested playbooks, a playbook execution engine 200 manages one or more function block execution queues (e.g., such as a function block execution queue 208). Each queue, for example, can be used to queue a different type of function block associated with playbooks executed by the playbook execution engine 200. For example, one function block execution queue can be used to queue and to subsequently delegate the execution of function blocks implemented using a first version of a programming language (e.g., function blocks implemented by code written in Python version 2.0), a second queue can be used to queue and to delegate execution of function blocks implemented using a second version of the programming language (e.g., function blocks implemented by code written in Python version 3.0, or implemented using a different programming language entirely such as Java®, Scala, etc.), while a third function block execution queue can be used to queue and to delegate execution of other types of commands (e.g., global updates, logging level changes, etc.).

As indicated above, the execution of a playbook by the playbook execution engine 200 generally involves the execution of function blocks defining the functionality of the playbook. However, in other examples, the playbook execution engine 200 can execute such function blocks more generally as a collection of commands defined by the engine, where the execution of each command correspond to one or more of a playbooks' function blocks or may correspond to other types of operations that relate to the context of a playbook's execution (e.g., commands to enqueue custom functions, and the like). In this example, the execution of a playbook can be initiated by a playbook run command that generates additional commands with a same playbook run identifier. A playbook execution is then considered complete once all commands associated with a corresponding playbook run identifier have been processed and a “finish” command is invoked. As described in more detail hereinafter, during execution of a playbook, function blocks or commands can be enqueued directly by the playbook execution engine 200 or via inter-process communications from a worker process. Thus, it may be understood that references to the execution of function blocks by the playbook execution engine 200 can further involve the management and execution of commands or other additional data constructs as part of a playbook's execution.

Responsive to a playbook execution engine 200 receiving a request 210 to execute a playbook, the playbook execution engine 200 determines, based on metadata associated with the playbook or with the function blocks of the playbook, a queue in which to place each of the respective playbook function blocks as needed. The metadata associated with the playbook or function block may indicate, for example, a type and version of programming language associated with a function block, expected input and output data types, dependencies on other function blocks in the same playbook or dependencies with other playbooks, and the like. Based on this information, the playbook execution engine 200 can add one or more of the function blocks associated with a playbook into a corresponding queue (e.g., function block execution queue 208) once it is determined that a function block is to be executed (e.g., based on identification of the function block as a next action by a previously executed function block in the same playbook or based on any other condition).

As indicated herein, the playbooks and associated function blocks can be stored as data objects in a database managed by the IT and security operations application 100 (e.g., a dedicated playbooks database 204 or other data store). The retrieval of a playbook and associated function blocks thus may involve obtaining the associated data from the database, e.g., including playbook metadata, function block metadata (e.g., indicating inputs and outputs, function block dependencies, identification of downstream function blocks, etc.), and function block code as needed. In some examples, upon receiving a request to execute a playbook, the playbook execution engine 200 obtains all the data associated with the playbook from the data store and executes individual function blocks as needed. In other examples, the playbook execution engine 200 obtains individual function blocks from the database on-demand during execution of a playbook (e.g., a function block can be obtained only when the function block is encountered during execution of the playbook, while other functions that are not encountered may not be retrieved).

As indicated, in some examples, the function blocks of a playbook can be added to a function block execution queue of the playbook execution engine 200 on demand. For example, upon initiating execution of a playbook, the playbook execution engine 200 can initially enqueue a start block of the playbook for execution (or execute the start block without enqueuing it), where data associated with the start block identifies one or more subsequent function blocks to execute (e.g., as defined by a control flow associated with the playbook and linking the function blocks of the playbook to one another). Once the subsequent function blocks to execute are identified based on processing the start block, the function blocks can be added to one or more function block execution queues based on metadata identifying characteristics of the function blocks, as described above.

In the example of FIG. 2, the function block execution queue 208 has function block 206A, . . . , function block 206N from playbook 202, among other possible function blocks. The example illustrated in FIG. 2 illustrates an example state of an execution queue at a single point in time; in general, the status of each of a queue changes over time as new playbook executions are requested, as the execution of function blocks of the playbooks is invoked, and as the execution of additional function blocks is requested based on the execution of upstream function blocks.

In some examples, a function block execution queue is associated a “dispatcher” process responsible for managing the contents of the queue and for delegating the execution of function blocks in the associated queue to worker processes (e.g., to workers 212 running on one or more computing device(s) 214). In some examples, a dispatcher process monitors the queue and determines when a function block is ready for execution (for example, when any dependencies associated with the function block have been fulfilled or based on other conditions). Once identified, the dispatcher process determines whether there is an available worker 212 that can execute the function block. For example, the dispatcher process can determine whether there exists a worker that hosts an appropriate execution environment (e.g., an execution environment 216 compatible with the programming language and programming language version of the function block) and that is not currently busy (e.g., one that is not executing other function blocks or performing other management operations).

In some examples, the playbook execution engine 200 maintains state information about the existence and status of workers 212 that can be used by the dispatcher processes to execute function blocks. The state information associated with a fleet of workers, for example, can include identifiers of currently instantiated workers 212, a type of execution environment associated with each worker, a status of each worker (e.g., idle, executing a function block, unknown, etc.), a playbook run identifier associated with each worker, among other possible information. In some examples, the status of each worker is determined in part based on inter-process communications (IPC) or other messages exchanged between the playbook execution engine 200 and the workers during operation.

The execution of function blocks of a same playbook can involve the use of shared context or state information, for example, based on the use of one or more global variables or data structures in the playbook that are referenced in two or more function blocks. In this example, the identification of a suitable worker can involve the dispatcher process determining whether there is an existing worker that is executing function blocks associated with a same playbook run identifier. In this manner, the playbook execution engine 200 can maintain an affinity between a playbook and a worker such that the worker can maintain state that is used among two or more separate function blocks of the playbook. In other examples, the execution of each function block of a playbook is stateless and a function block can be executed by a same or different worker relative to workers used to execute other function blocks from the same playbook.

If a dispatcher process is unable to identify an existing worker capable of executing a pending function block, in some examples, the dispatcher process or playbook execution engine 200 can instantiate a new worker process depending on a scaling limit associated with the playbook execution engine 200. For example, in general, any number of separate worker processes can be created to concurrently execute function blocks while maintaining function block dependencies as discussed herein. However, optionally, a maximum scaling limit can be used to limit a total number of worker processes that can be instantiated at any given time (e.g., to ensure that available CPU, memory, or other resources are not overutilized). In some examples, the maximum scaling limit can be specified by a user of the IT and security operations application 100 and modified as desired (e.g., based on an amount of computing resources that the user has allocated to the execution of the IT and security operations application 100). In this manner, if it does not violate any defined scaling limits, a dispatcher process can instantiate a new worker if an available worker for a given function block is not available. The instantiation of a new worker 212 can include, for example, creating a new child process, launching a new VM or container, invoking an on-demand executable function, or causing the instantiation of any other type of computing resource used to host a copy of an execution environment suitable for executing function blocks.

The creation of a new worker can, in some examples, involve creating a worker capable of hosting a specific type of execution environment from a plurality of possible execution environments. For example, if the playbook execution engine 200 supports multiple different programming languages or programming language versions, the playbook execution engine can launch workers with an execution environment specific to each programming language or programming language version. In some examples, a worker also generally includes functionality capable of receiving IPC or other messages from a playbook execution engine 200 to execute function blocks, to receive other system state information, to optionally queue multiple function blocks for execution, to obtain playbook, function block, and incident data from one or more external databases or other data sources, to execute function blocks, to optionally maintain state information used across multiple function blocks, to obtain a result of a function block execution and determine a next action (e.g., return one or more values, identify one or more subsequent function blocks to execute, etc.), to format a response to the playbook execution engine 200 indicating the function block execution results, to report error or other logging information, and the like.

Once an available worker is identified, in some examples, the playbook execution engine 200 sends a request (e.g., via an IPC message, API, or other interface) to the worker to execute the function block. In some examples, the request includes structured or semi-structured data (e.g., JSON or XML-formatted data) identifying the function block among other possible status information. Upon receiving a request to execute a function block, in some examples, the worker 212 obtains information about the function block from a database (e.g., playbook database 204). The information about the function block can include the program code associated with the block, function block metadata, and the like. In FIG. 2, for example, a worker 212 has received a request to execute a function block 206A using the hosted execution environment 216; similarly, other workers 212 can receive a request to execute other function blocks using other hosted execution environments.

As indicated above, each of execution environments 216 can support the execution of a same type of function block or may each respectively support the execution of different types of function blocks (e.g., function blocks defined by program code written in different programming languages or programming language versions). Furthermore, different workers can potentially concurrently execute separate function blocks from a same playbook (subject to any function block dependency considerations). In this manner, the distributed set of workers 212 enables the execution of function blocks of a same playbook, function blocks from different playbooks, and function blocks associated with different execution environments to be vertically scaled. As illustrated, the workers execute on one or more computing device(s) 214 (one or more of which may also be responsible for executing the playbook execution engine 200), where a number of computing device(s) 214 can be scaled as needed to support more or fewer workers in a given environment.

In some examples, upon obtaining any data used to execute a function block that has been assigned to a worker, the worker causes execution of the function block using its respective execution environment. For example, the worker can cause program code associated with the function block to be executed by an interpreter or other execution environment suitable for the type of programming language used for the function block. As indicated herein, a function block generally can cause the performance of a wide range of actions involving an IT environment including, e.g., modifying settings associated with a computing asset, obtaining enrichment data from various data sources, executing search queries (e.g., against data stored by the IT and security operations application 100 or data intake and query system 114), etc., and can include custom code provided by a user of an IT and security operations application 100.

Once a function block is executed, either by the playbook execution engine 200 or one of the workers, the engine or a worker generates results information including, for example, any output values associated with execution of the function block and an indication of one or more downstream blocks to be executed following the function block (where such function blocks, e.g., may receive as input one or more of the output values of the executed function block and possibly from other function blocks). In some examples, a worker sends a message including the function block execution results back to the playbook execution engine 200. As indicated above, the playbook execution engine 200 uses information about the results of a function block execution to identify additional function blocks in the various queues to execute next, to enqueue one or more additional function blocks, among other possible operations. For any given playbook, the playbook execution engine 200 can continue executing the playbook this manner until an end state is reached in the execution of the playbook (e.g., as identified by an end block), at which point the playbook execution engine 200 can return status information to other components of the IT and security operations application 100 (e.g., indicating whether execution of the playbook was successful, an elapsed time to execute the playbook, etc.).

In some examples, the playbook execution engine 200 creates a “run record” and an associated run identifier for each playbook execution instance. For example, a run identifier can be associated with a playbook's function blocks such that function blocks associated with a same execution of a playbook are associated with a same run identifier (and corresponding run record). In this manner, a respective context associated with each of multiple concurrent executions of a same playbook can be distinguished using the distinct run identifiers. For example, a function block execution queue 208 might contain multiple instances of a same function block from the playbook, but each instance of the function block is associated with a different run record via a respective run identifier.

The example illustrated in FIG. 2 further illustrates that the function blocks of a playbook can be further supplemented with code or other functionality used to collect playbook run statistics for each function block. For example, each of function block 206A, . . . , function block 206N is associated with a respective statistics collector 218, each representing additional code that, upon execution of the corresponding function block, collects and stores run statistics associated with the function block. As described in more detail herein, these statistics can include, for example, a number of database queries executed by a function block, an average latency of the database queries executed by the function block, an amount of time for the function block to execute, a number of bytes transmitted via Hypertext Transfer Protocol (HTTP) requests sent by the function block (e.g., executing the function block can include initiating interactions with a computing device or service that is external to the IT and security operations application and, thus, the playbook runs statistics can include statistics reflecting those interactions), a number of bytes transmitted via HTTP requests received by the function block, an average amount of time between HTTP requests sent by the function block and corresponding HTTP requests received by the function block, a number of HTTP requests sent by the function block, a number of times the block is executed, a number of times the function block completed successfully, a number of times the function block failed, and the like.

In some examples, users can enable the collection of playbook run statistics for individual playbooks, or for all of a users' playbooks, by providing input via a VPE or other interface of the IT and security operations application 100. In other examples, the collection of playbook run statistics is enabled by default and visible to users upon request to display the statistics for a selected playbook. Upon enabling the collection of playbook run statistics, in some examples, a VPE or other component automatically adds source code to the playbook that implements the collection of playbook run statistics. As indicated, the added source code is executed during execution of the playbook by the playbook execution engine 200, where the collected statistics are stored in a database (as run statistics 220 stored in the playbook database 204 or other data store). As shown, the statistics collector 218 can optionally store a separate function block resource usage record for each function block executed by a worker 212 (e.g., shown as function block resource usage record 222A, . . . , function block resource usage record 222N). In other examples, the statistics collected for a same playbook can be aggregated into a single record or other format stored in a playbook database 204 or other datastore accessible to the playbook execution engine 200 or workers 212.

In the example of Python-based playbooks, in some examples, the VPE or other component of the IT and security operations application 100 adds “decorators” to the code associated with each function block of the playbook. A decorator is syntax in Python for calling-higher order functions. In particular, a decorator is a function that takes another function as input and extends the behavior of the input function without explicitly modifying the function it “decorates.” In this example, the decorator added by the VPE calls a higher-order function that implements the collection of playbook run statistics for each function to which the decorator is added and stores a record with the collected statistics. In other examples, users can add the decorator to the code manually, e.g., to enable the IT and security operations application to collect statistics for custom function blocks or to add the functionality outside of a VPE.

The statistics collector 218 code that collects the statistics can, for example, obtain the statistics from the runtime executing the function block code and/or other components involved in the execution of the playbook code (e.g., any processes involved in implementing the playbook execution engine 200). Depending on the programming language or other type of code used to implement the playbooks, other types of statistics collectors 218 can be used such as, e.g., libraries, plug-ins, etc., capable of monitoring function block execution time, HTTP requests and responses, database calls and responses, and the like. As indicated, the collection of playbook run statistics can be performed for standard function blocks (e.g., ones provided by default in a VPE) and custom function blocks including custom code provided by a user of the IT and security operations application. In some examples, the statistics for a custom function block can be the same or different from those collected for standard function blocks, and the statistics for a custom function block can be stored in a same or different database or database table as those for the standard function blocks.

In some examples, the IT and security operations application 100 further includes one or more APIs used to return playbook resource metrics for one or more identified playbooks. The API can further enable query parameters such as function block identifiers, playbook run identifiers, and time ranges. The function block identifier parameter, for example, can be used to obtain playbook run statistics for only one or more specified function blocks of a playbook; the playbook run identifiers can be used to obtain playbook run statistics for only one or more specified playbook runs; and the time range parameter can be used to filter the playbook run statistics to only a specified range of time. In some examples, the API can be controlled by playbook permissions such that, e.g., the playbook run statistics for a particular playbook can be accessed only if an account associated with the request has permissions to access the playbook. The API can be used by other components of the IT and security operations application to display the statistics in a VPE or interface or used by any other process to obtain the statistics for use.

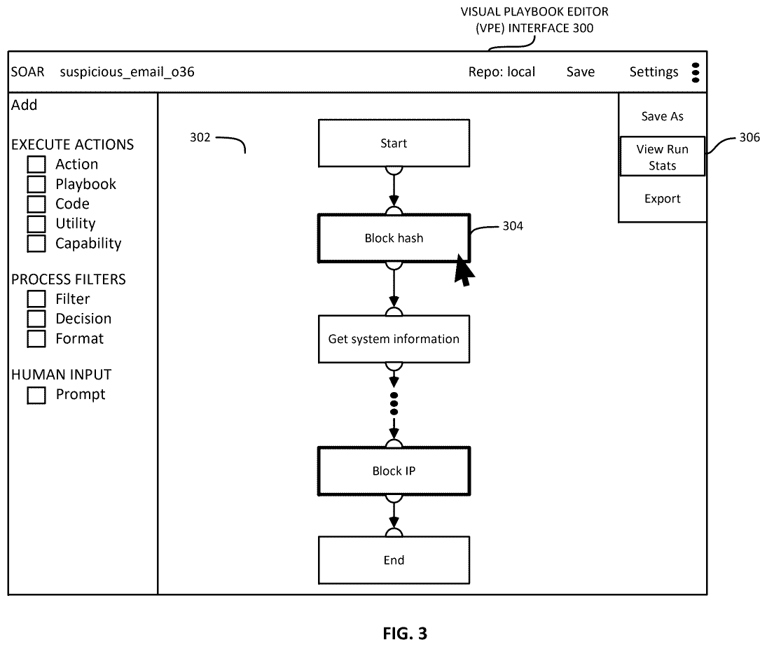

FIG. 3 illustrates a portion of an example graphical user interface (GUI) including a VPE interface 300 according to some examples, in accordance with embodiments according to the present disclosure. This example VPE interface 300 may show some aspects of the VPE that may be combined with any other aspects and example interfaces disclosed herein according to various embodiments. The VPE interface 300, for example, may include a playbook canvas 302 showing a playbook including several function blocks including, e.g., a function block 304. The VPE interface 300 may further include interface elements that enable a user to save a playbook under development, to export the playbook out of the VPE, and to view playbook run statistics for the playbook (e.g., by selecting the menu item 306). Once selected, the VPE may cause display of a report or other interface indicating the playbook run statistics that have been collected for the playbook.

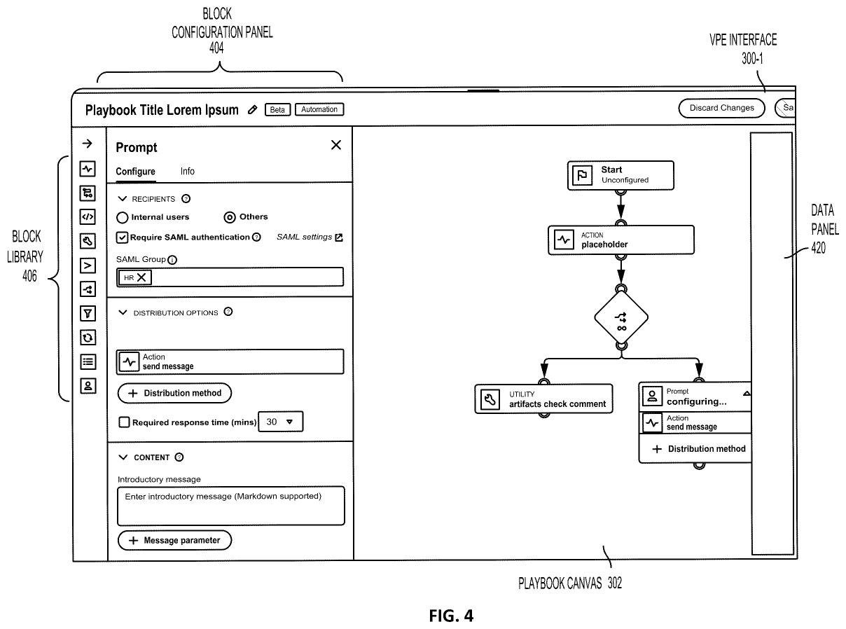

FIG. 4 illustrates a portion of another example VPE interface 300-1 according to some examples, in accordance with embodiments according to the present disclosure. This example VPE interface 300-1 may show some aspects of the VPE that may be combined with any other aspects and example interfaces disclosed herein according to various embodiments. In this example VPE interface 300-1, a user may focus on defining a playbook in terms of a dataflow. For example, the user may contemplate particular orderings of actions to be performed, how data is to be obtained, transformed, used to generate other data, etc. in order to define a playbook. As shown, the VPE interface 300-1 includes a playbook canvas 302 showing a representation of a graph type structure that a user can utilize to define the dataflow (e.g., by dragging and dropping block/action type structures from a library 406 onto the playbook canvas 302, combining the blocks, etc.), as well as a block configuration panel 404 enabling user-provided configuration data for the blocks to customize how they operate. In some examples, the VPE interface 300-1 may include a data panel 420 that can provide visibility into data for data-based playbook generation and testing.

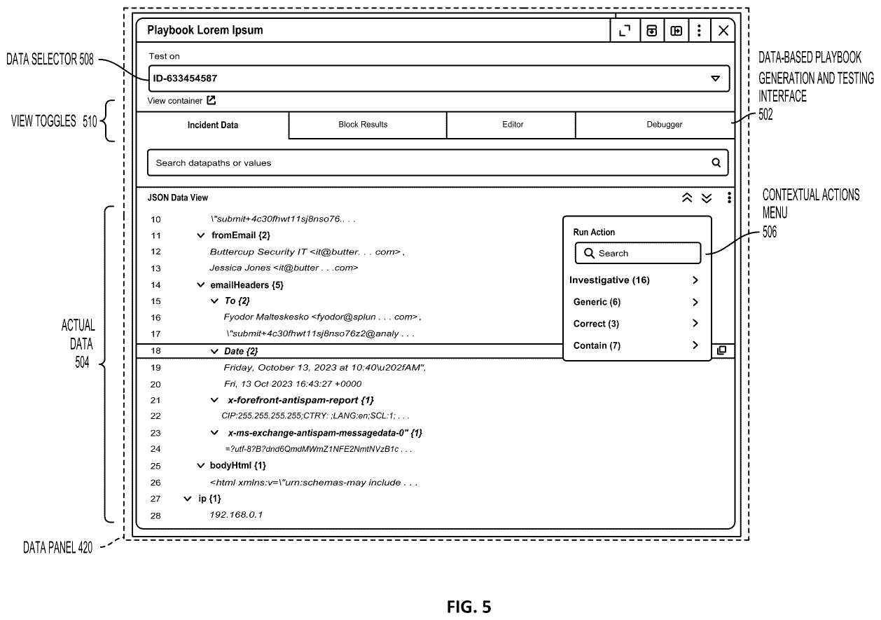

FIG. 5 illustrates a portion of an example data-based playbook generation and testing interface 502 of the VPE interface 300 according to some examples. This example data-based playbook generation and testing interface 502 may show some aspects of the VPE that may be combined with any other aspects and example interfaces disclosed herein according to various embodiments. As part of supporting a user in creating or editing a playbook, the IT and security operations application can provide one or more interfaces, such as data-based playbook generation and testing interface 502, enabling a user to generate and/or configure portions (or all) of a playbook based on use of actual data 504 associated with one or more IT environments of the user (or the user's organization, etc.). This data-based playbook generation and testing interface 502 may, in some examples, be shown within a data panel 420 along with a playbook canvas 302, etc., to allow for simultaneous visibility of both the data (e.g., incident artifact data) and playbook under construction. In this manner, the creation of a playbook can be more data-driven and intuitive for users by allowing these users to identify actions to be performed by looking at actual data and seeing the actual output of these actions as performed on that data.

As shown, a user may utilize a data-based playbook generation and testing interface 502 to create (or update) a playbook, here named “Lorem Ipsum,” where the user may use a data selector 508 user interface input element (here, a dropdown box) to select a particular collection (or “container”) of one or more actual data 504 elements to use as part of configuring the playbook. In this example, the user has selected data associated with a particular identifier (“ID-633454587”), which could include data (or “artifact data”) from a security incident, investigation, or other collection of data associated with the user or user's organization as described herein. In some examples, the identifier may be associated with a container having a context that is akin to a dictionary that captures and organizes container data and the results from integration actions and custom functions. This container can use text strings as keys, with values ranging from text and numbers to booleans, maps, lists, etc. This context can be used for moving data between playbook tasks—e.g., storing the output from one task and making it available for the next.

In some examples, the data-based playbook generation and testing interface 502 allows users to have a visual interface into this context data in an easily navigable, clear format. This visibility aids in configuring playbook blocks, as users can directly utilize the information stored in the container context for virtual playbook editor block inputs, ensuring a seamless and efficient workflow in playbook development. In this example, upon selecting a particular collection of data via the data selector 508, the data-based playbook generation and testing interface 502 updates a data panel of the interface to show some or all of the associated actual data 504 for the user's viewing. In this case, the actual data 504 is incident data collected from one or more sources in association with a detected security incident and is shown due to an incident data view toggle 510 user interface input element (e.g., one of a collection of buttons, tabs, links, etc.) being selected. In this case, the actual data 504 is JSON (JavaScript Object Notation®) formatted data, and the illustrated portion includes such data elements pertaining to an email, such as the originating source email address (as “fromEmail”), a variety of email headers (from “emailHeaders”, including a “To” address, a “Date”, and two different antispam report values), an email body (as “bodyHtml”), an associated IP address, and the like. Of course, many other types of data may be displayed, such as data obtained from a web server, firewall, database, router, gateway, authentication and/or authorization server, anti-malware and/or anti-spam engine, etc., which can be differently formatted. For example, there may be multiple different artifacts associated with a particular collection or incident, and the user may view the actual data 504 of ones of these artifacts (e.g., one at a time).

Upon a user selecting a portion of the data that is of interest to the user—e.g., an IP address—the IT and security operations application (via the interface 502) may suggest one or more actions that can be performed using that data (e.g., calling a geolocation function, causing traffic associated with that address to be blocked via a firewall rule or otherwise modified, causing additional analysis to be enabled for future traffic associated with that address, etc.). In other examples, this suggestion may be provided based on the actual data 504 element as a whole (as opposed to just a selected portion of the data).

In some examples the IT and security operations application generates these suggested actions by identifying a type of the selected data (e.g., an IP address, date, email address, etc.) and identifying one or more types of available actions (configured in the playbook editor, such as via “apps”) that are associated with that type of data. For example, an action associated with an enabled app may identify a type of input data it expects; this action could be suggested to the user. The IT and security operations application, in some examples, determines a type of the selected data by analyzing surrounding data—e.g., a parent node of the selected node may indicate its type. In some examples, the IT and security operations application may use one or more machine learning models (e.g., classifiers, language models, etc.) trained to identify particular types of data (or that are able to identify particular types of data). Thus, the user-selected portion of data of interest (e.g., highlighted or otherwise selected), and possibly some surrounding data, may be input to one or more models to identify its type.

As another example, in another configuration the IT and security operations application may identify, based on an analysis of other playbooks (of the same customer, and/or of other customers, assuming those customers have opted-in to sharing this type of information), actions that are observed to have been performed for that type of data. This data, in some examples, may be identified and stored in a mapping data structure (e.g., keeping track of actions associated with data types, potentially with counts indicating how often an action is observed as being associated with the data type). In some examples, though, playbook data may be provided to a machine learning model (as part of its training and/or prompting), thereby allowing the machine learning model to identify suggested actions based on the playbook data itself. Additionally, or alternatively, this analysis may be made without a user-selection of a particular data element of interest. For example, the IT and security operations application may analyze the entirety of the viewed actual data 504 (and possibly other data associated with the loaded incident data), for example, by providing it as part of an input to a machine learning model (e.g., a large language model), prompting the model to identify data elements (from the data) that may be worth investigating and/or suggesting actions based on this data.

Moreover, in some examples, the IT and security operations application may enable a user to access any action that is available for use in a playbook for that user. Thus, a contextual actions menu 506 may be configured to provide a listing (here, a multi-level listing, where different types of actions are grouped as being “investigative,” “correct,” etc.) of all available actions for the user to browse and select for testing and/or inclusion in a playbook. However, in some cases this listing presented via the contextual actions menu 506 may be filtered such that only usable actions can be viewed, e.g., based on a type of expected input for the action matching a type of data that is selected (or otherwise present in the actual data 504).

Upon a user selecting an action of interest, the data-based playbook generation and testing interface 502 may perform a test run of the action on this data 504 and/or add it to a playbook under construction. In some examples, a user may select an action of interest from the contextual actions menu 506, which causes the IT and security operations application to run the action on the associated actual data 504. The results of the test run may be provided via the data-based playbook generation and testing interface 502, for example, in a “block results” pane (either automatically shown, or selectable by the user via view toggles 510). This allows a user near-instant feedback detailing exactly what an output for a block (associated with the action) would look like, using real data, to allow the user to more fully and intuitively grasp how the block would operate as part of the playbook. As one example, an action of geolocating an inputted IP address from the data may yield a test result of “San Francisco, California”, which may be presented to the user via the interface. As another example, an action of performing a “whois” lookup for a domain (present in the data) may yield a test result including domain information, registry information, domain status information, contact information, name server information, etc., in a “raw” machine format and/or in a more human-friendly format. In some examples, the “block results” pane will show the inputs and/or outputs (simulated or real) of one or more (or all) blocks of the current playbook based on the currently selected collection/container of data.

In some examples, this test run of an action may be based on the IT and security operations application generating code for a block that invokes the action. This code (or a visual representation thereof, such as a graph) may be presented to the user via another panel of the interface 502 (e.g., an editor panel). In some examples, the user may further modify the code or configuration for this block and then test its operation once more to verify that an actual result matches the user's expected result. The interface 502 may also include a debugging panel, e.g., selectable via view toggles 510, allowing the user to explore the execution of a block at a more granular level, such as on a step-by-step basis. At some point, the data-based playbook generation and testing interface 502 may present user interface input elements enabling the user to add a configured block to a playbook. This block may later be modified via the other elements of the VPE interface presented herein or may be further tested using the data-based playbook generation and testing interface 502.

In some examples, data-based playbook generation and testing interface 502 may also provide sample data that may not be associated with the user (or user's organization/system). For example, the system may be configured with sample data, which could be completely synthetic (e.g., constructed by a human or machine learning model) or from another user or organization, again assuming that the latter user or organization has explicitly opted-in and thus consented to this sharing. The sample data may correspond to examples (e.g., examples of values, substance, formatting, correspondence, precision) of data that could be outputs of particular input parameters, artifacts, action blocks, and/or results, as disclosed herein. Particular sample data may be a function of the type of input parameter, type of artifact, type of action block, and/or type of result and may be particularized to a particular input parameter, particular artifact, particular action block, and/or particular result. In some examples, at least some sample data may correspond to metadata that is provided by the data-based playbook generation and testing interface 502. Sample data is distinct from real data (which may also be referenced herein as actual data) as used herein. While sample data may provide example of what the real/actual data may be like, real/actual data, by contrast, may be associated with the user or the user's organization/system. Real/actual data may correspond to any body of data that the user may run a playback against and may be accessed (by any suitable means such as a network data path, API calls, and/or the like) from the user's computing device, computing system, and/or one or more remote data sources in accordance with the execution of the playback. A user may be able toggle between sample data and real/actual data in the data-based playbook generation and testing interface 502.

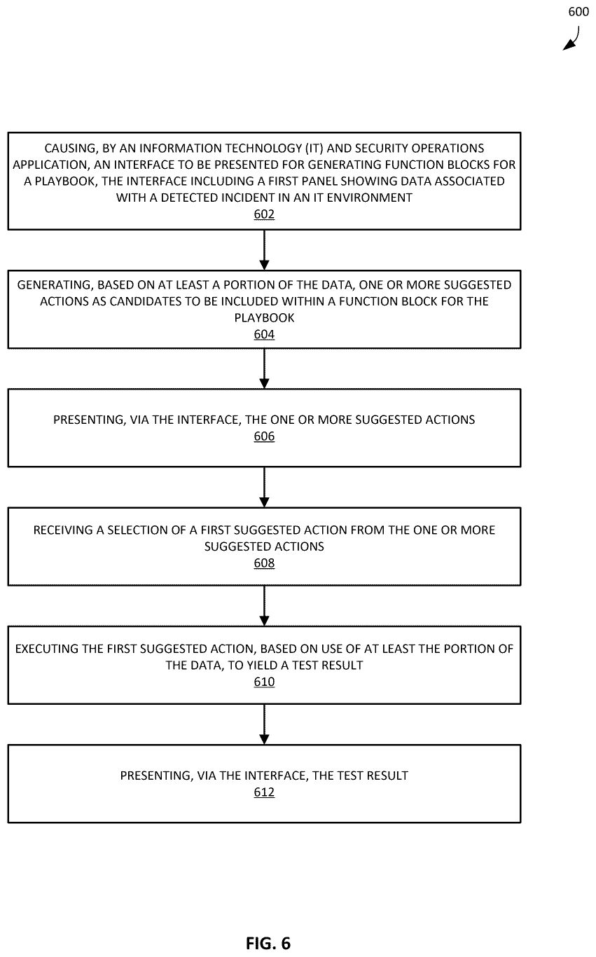

FIG. 6 is a flowchart illustrating an example process 600 for data-driven playbook generation according to some examples. The example process 600 may be implemented, for example, by a system including a computing device that comprises a processor and a non-transitory computer-readable medium. The non-transitory computer readable medium may be storing instructions that, when executed by the processor, may cause the processor to perform the operations of the illustrated process 600. Alternatively, or additionally, the process 600 may be implemented using a non-transitory computer-readable medium storing instructions that, when executed by one or more processors, cause a system including the one or more processors to perform the operations of the process 600 of FIG. 6.

The process 600 may include one or a combination of the following. As indicated by block 602, an information technology (IT) and security operations application may cause an interface to be presented for generating function blocks for a playbook. The interface may include a first panel (e.g., data panel 420) showing data associated with a detected incident in an IT environment. As indicated by block 604, one or more suggested actions may be generated, based on at least a portion of the data, as candidates to be included within a function block for the playbook. As indicated by block 606, the one or more suggested actions may be presented via the interface. As indicated by block 608, a selection of a first suggested action from the one or more suggested actions may be received. As indicated by block 610, the first suggested action executed, based at least in part on use of at least the portion of the data, to yield a test result. As indicated by block 612, the test result may be presented via the interface. Further details, extensions, and features may elaborate on the process 600, which are described in the following.

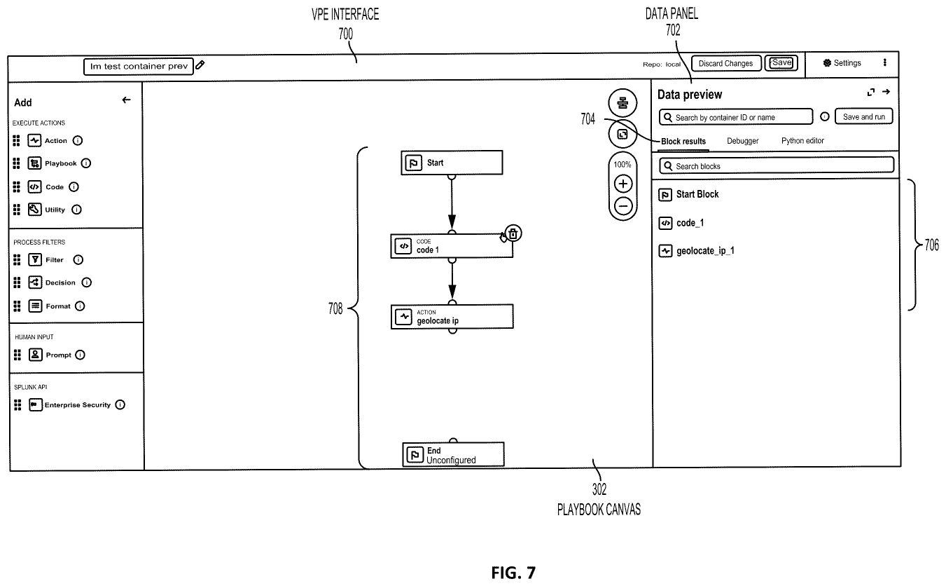

FIG. 7 illustrates another example VPE interface 700 according to some examples.

This example VPE interface 700 may show some aspects of the VPE that may be combined with any other aspects and example interfaces disclosed herein according to various embodiments. The VPE interface 700 may, for example, correspond to the VPE interfaces 300, 300-1 and may provide an example of a container preview functionality of the VPE interfaces 300, 300-1, which may correspond to a low-code VPE with data preview features. The VPE interface 700 may solve problems that a user may run into with conventional approaches in building playbooks when the user does not have knowledge of exactly what information is available on the system, what information is available off of the exact event that the user wants to run their playbook against, or any of the information that the user may be using, including universal data paths-data paths related to the artifacts and events themselves, or data paths related to the playbook itself-down to the internals of the playbook. When a user is building a playbook, the user may not see the actual data that the user might be working with. Instead, the user may see abstracted data paths (e.g., artifact.*.destinationURL or artifact.*.destinationIP, or virus_total.*.reputation), where the user may only be assuming what data is actually being referenced (e.g., assume that they are going to reference the correct destination URL, destination IP, or reputation), which may introduce some issues regarding whether the right data is being referenced, whether the name is misleading, etc. The user does not know what the data path variable from somewhere upstream in the playbook will resolve to. So, the user may not be able to determine that information until after the user saves the playbook and then uses the debugger to run the playbook. This may require the user to make a change by guessing, saving the playbook, running the playbook, waiting, and then having to sift through logs to determine what information would be useful for building the playbook.

To solve such problems, the VPE interface 700 may include features, such as container preview provide with a data preview panel 702. The container preview may show what a data path represents with in a specific container. The data preview panel 702 of the VPE interface 700 may correspond to the data-based playbook generation and testing interface 502 and the data panel 420 in some embodiments and may be referenced herein as “data panel.” The data preview panel 702 may include a block results tab 704 that may correspond to the container preview. The container preview may include references 706 that include a reference to each of function blocks 708 (which may correspond to function block 304 described earlier) that are currently on the playbook canvas 302 and configurable within the VPE interface 700 (e.g., a start block, a code block, and an action block as illustrated). As the user adds and/or removes a variety of function blocks 708 and container pointing data paths by selecting interface elements of the VPE interface 700, the container preview may be updated in real time to accurately reflect the changes with an updated list of references 706 to the function blocks 708.

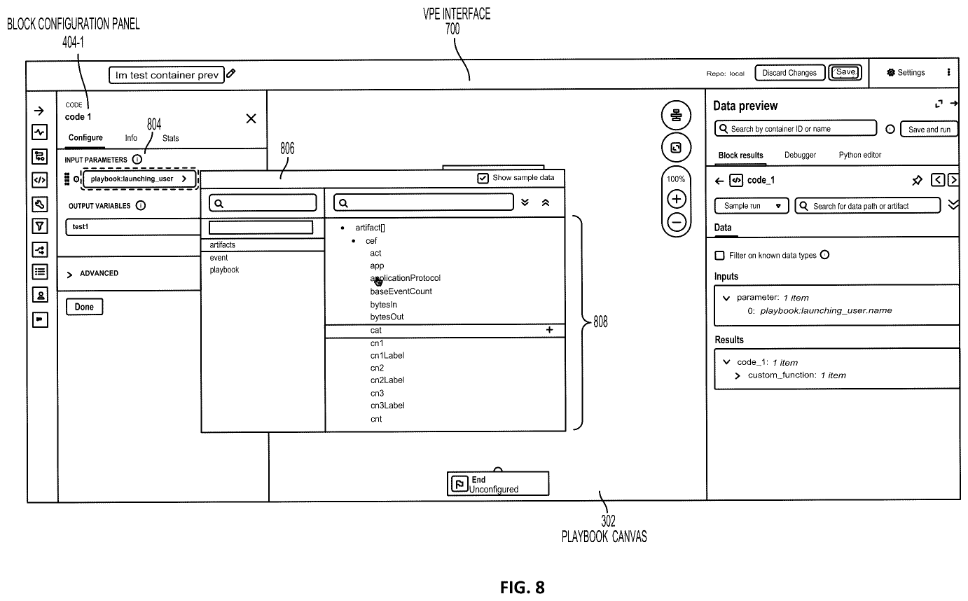

For example, FIG. 8 illustrates how the VPE interface 700 provides a block configuration panel 404-1 to allow a user to configure a code block by selecting input parameters 804 according to some examples. An incident may be specified, and all the artifacts (e.g., IP addresses, rules, alerts, various contextual items) that are associated with that incident may be exposed. For example, a modal 806 may pop up with references to the existing data paths within the platform. The modal 806 may expose various options such as a list of artifacts 808 from which the user may select input parameters to configure the code block. The user may manipulate user interface elements on the playbook canvas 302 to add the function block (e.g., for an artifact that is an IP address, an IP reputation block to do a reputation analysis on the IP address and produce a corresponding score may be added to the playbook). Then, the container preview may automatically update reflect the addition with an updated list of references 706 to the function blocks 708 (shown in FIG. 7).

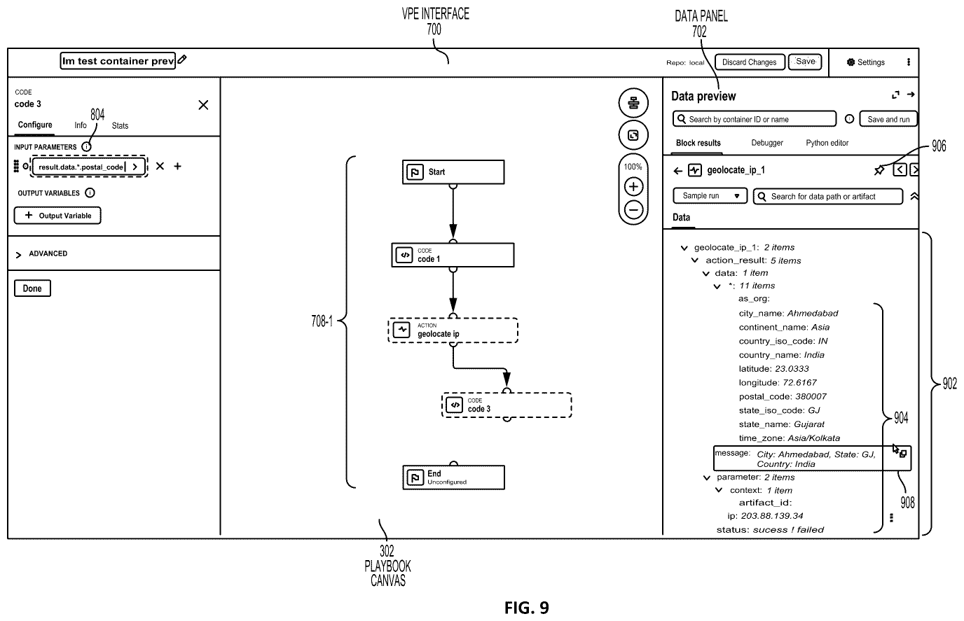

The VPE interface 700 may expose automatically, or upon user selection, data corresponding to a data path selector for the function blocks 708, with sample data automatically provided. FIG. 9 illustrates data path selector data 902 that may be exposed with the data preview panel 702 according to some examples. In the depicted example, the data preview panel 702 may include the data path selector data 902, which may correspond to the action function block “geolocate_ip.” The data path selector data 902 may be collapsed or expanded upon user selection of user-selectable interface options according to a hierarchy of the data path selector data 902. The data path selector data 902 may showcase all the outputs for the action block, including sample data 904 for each (e.g., after the colons of the outputs, such as “Ahmedabad” being the sample data for “city_name” in the depicted example). The sample data may be graphically distinguished (e.g., by color-coding, emphasis, highlighting, font size, annotation, or any other suitable way) from other elements of the data preview panel 702 and from actual data. Thus, the data preview panel 702 may show the flow of the outputs with associated sample data as the user is building a playbook.

A user-selectable option 906 may allow for pinning the data path selector data 902 to provide for persistence. Should the user want to see exactly what the block output data provides, user-selectable options 908 may allow for copying particular data from the data path selector data 902 so that the particular data may be pasted into the input parameters 804 field to expose the corresponding data directly, rather than having to search through hierarchical menu selections for the corresponding data.

With the data provided by the data preview panel 702 as a user is building a playbook, the data preview panel 702 may show the data that the playbook is actually referencing as it is being built. Moreover, the data preview panel 702 may accelerate the building of a playbook with workflow features that may include providing user-selectable recommended actions as a function of a specific incident that are recommended to operate on particular data types in one or more data paths of the playbook. For example, say a data type corresponds to an IP address or a domain. The user may select data corresponding to that data, and the data preview panel 702 may identify and present recommended actions that are fine-tuned for that data type. Once the user selects a recommended action, a corresponding function block 708-1 may be added to the playbook canvas 302, and the IP address or domain may already be configured in that function block 708-1 appropriately.

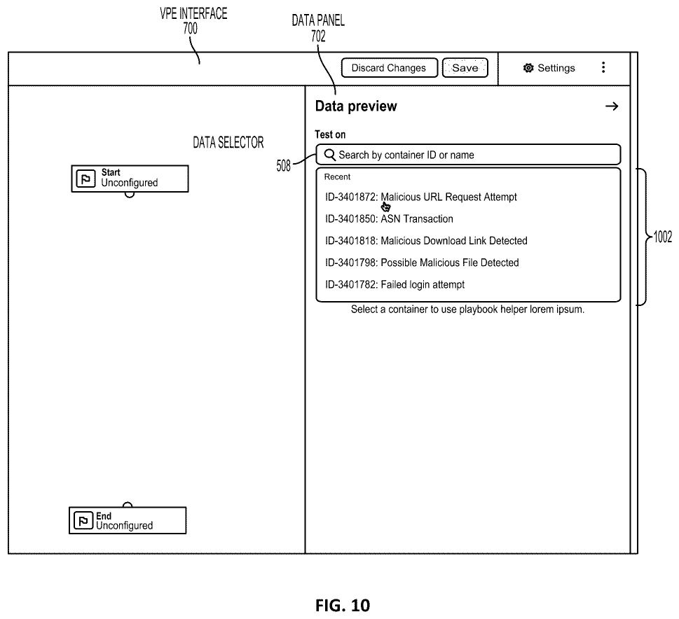

FIG. 10 illustrates a portion of the VPE interface 700 to illustrate how the data preview panel 702 may allow for a user to specify an incident according to some examples. The data selector 508 of the data preview panel 702 may include an incident field that exposes a dropdown list of incidents 1002 from which a user may select an incident. In the depicted example, an incident corresponding to a malicious URL request attempt may be selected, for example. Once the user specifies the incident with a selection of one of the incidents, a start block may be added to the list of references 706 of the container preview in the manner illustrated above with respect to FIG. 7. The user may select the start block from the container preview. Responsive to that selection, real artifacts associated with that incident may be exposed in the data preview panel 702.

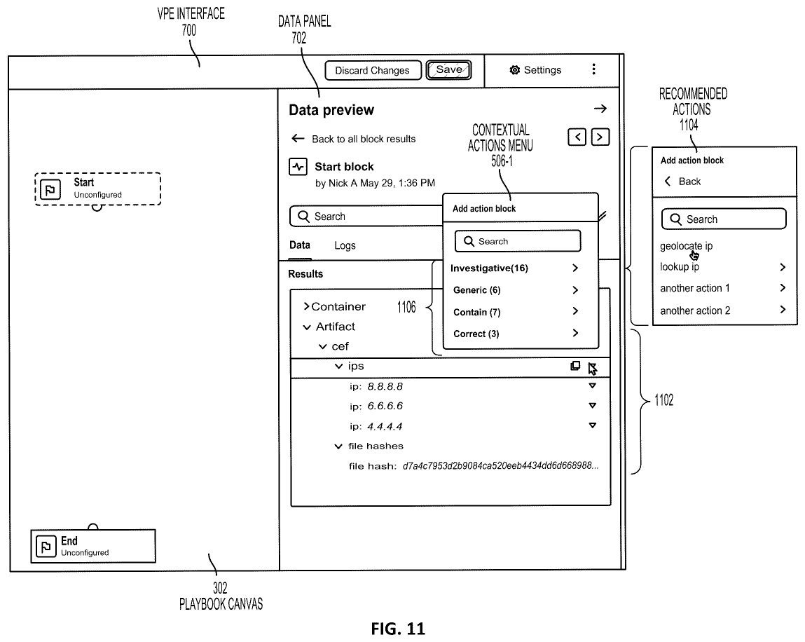

FIG. 11 illustrates an example of the data preview panel 702 after a block has been selected from the container preview according to some examples. In this illustration, the real artifacts 1102 associated with that incident and the start block are exposed in the data preview panel 702. In the depicted example, IP addresses are included in the expandable listing of artifacts 1102. The VPE interface 700 may utilize some metadata that alongside the outputs to identify recommended actions 1104 that may be created off of the data paths corresponding to items presented in the data preview panel 702. In the example depicted, each of the real artifacts 1102 presented in the data preview panel 702 may be user-selectable to reveal the contextual actions menu 506-1. The contextual actions menu 506-1 may generate and present recommended actions 1104 as a function of the context of a particular state of the data preview panel 702—i.e., of particular items of data presented in the data preview panel 702, in the depicted case, as a function of the selected real artifacts 1102.

In the depicted example, the contextual actions menu 506-1 is exposed responsive to a selection of the IP addresses. The contextual actions menu 506-1 may present a dropdown list of various action categories 1106 of recommended actions 1104 to add an action block corresponding to the IP addresses. The depicted example shows example investigative, generic, contain, and correction action categories 1106 from which the user may choose. Say the user selects the investigative category from the dropdown list. Responsive to that investigative category selection, a dropdown list of the relevant actions 1104 for that investigative category may be exposed. The depicted example shows example relevant actions 1104 including geolocate IP and lookup IP, among other relevant actions. Say the user selects the geolocate IP relevant action. Responsive to that relevant action selection, an action block corresponding to that relevant action may be added to the playbook canvas 302 automatically as connected with a connector to the previous block (in the depicted example, the start block), in a configured state with the corresponding field within that action block prepopulated with the corresponding data path from that previous block. The connector may correspond to code (e.g., Python® code) mapped to one or more actions, where each action has its own inputs and outputs specified.

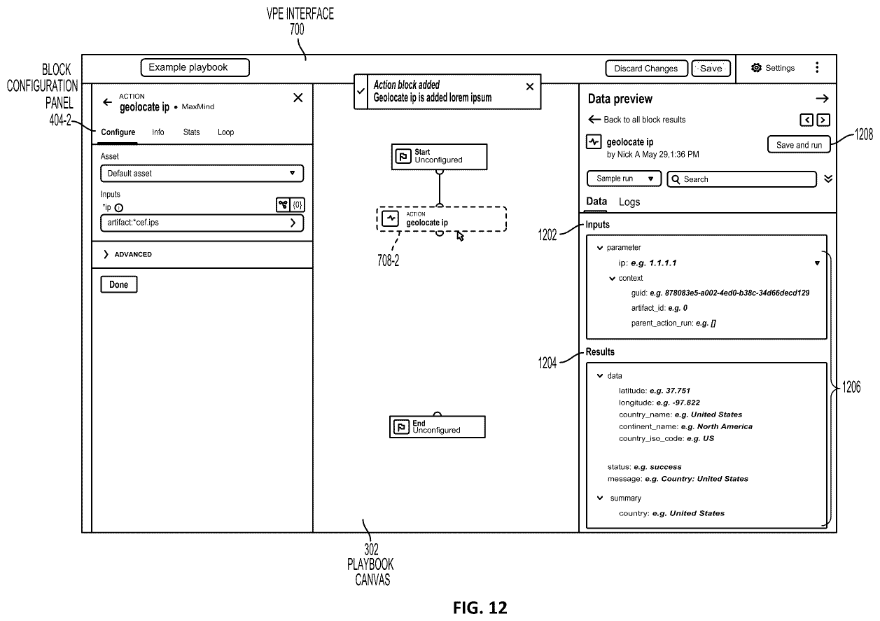

FIG. 12 illustrates an example of a portion of the VPE interface 700 after the action block 708-2 has been added to the playbook canvas 302 according to some examples. The action block 708-2 has already been configured, as indicated by the automatically updated block configuration panel 404-2. Thus, the correct data path may be passed into the correct parameter. Accordingly, the work needed for the action block 708-2 is almost complete. As illustrated, the data preview panel 702 has been updated showing inputs 1202 and results 1204 with sample data 1206 for outputs of the action block 708-2. The sample data 1206 may correspond to examples of data that may exist with the outputs of the action block 708-2.

Generally, with various instances of the playbook disclosed herein, each artifact, input, result, and action function block may be configured with sample data. The sample data may be particularized to each type of artifact, type of input, type of result, and type of action function block. For example, sample data particularized to geolocate IP (e.g., an IP address) may be associated that action block to give an example of the data that may come from that action function block. Thus, various fields may be mapped to particular data types, so, when, for example, a relevant action is presented to a user, the sample data for that action may be presented.

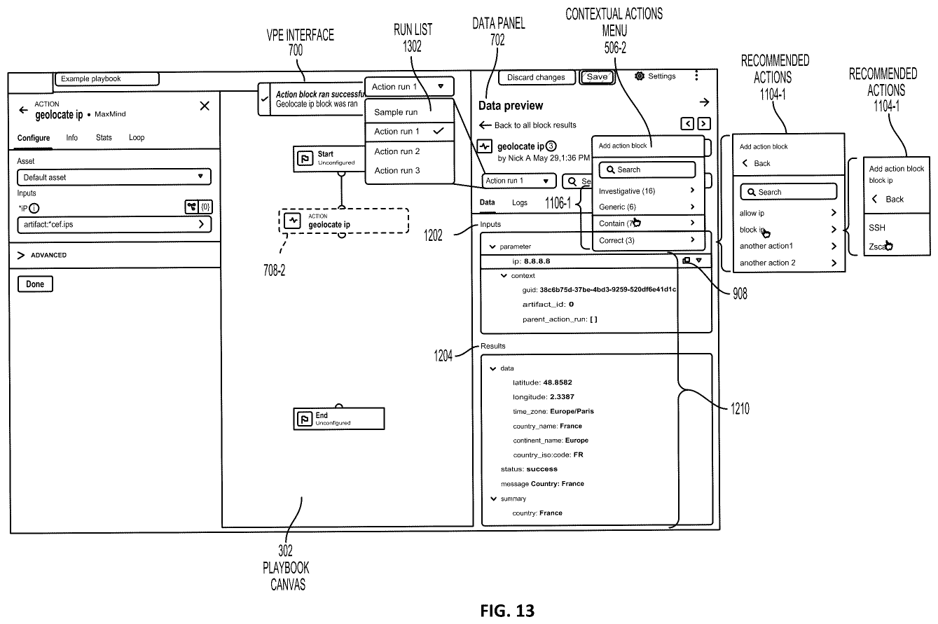

Continuing with the above example, the user may select a save and run option 1208 to save and run the action block 708-2. FIG. 13 illustrates an example portion of the VPE interface 700 after the action block 708-2 has been saved and run according to some examples. As illustrated, the data preview panel 702 has been updated to present the inputs 1202 and results 1204 with the real data 1210 produced from that run. The real data may be graphically distinguished (e.g., by color-coding, emphasis, highlighting, font size, annotation, or any other suitable way) from other elements of the data preview panel and from the presentation of sample data. Thus, when the user tests an action block or the whole playbook, the data preview panel 702 may instantly present the actual data elements corresponding to the action block or playbook. The user may use the actual data to debug more efficiently, if debugging is needed, as the user is able to see the exact actual data that the action block or playbook has run against. Additionally, user-selectable options 908 (e.g., hover-over-to-reveal options) may allow for data paths of particular elements to be copied. A copied data path may, for example, be pasted into an action function block.

Again, each of the inputs 1202 and results 1204 may be user-selectable to reveal the contextual actions menu 506-2 and recommended actions 1104-1 for the selected input or result. In the depicted example, recommended actions 1104-1 are exposed responsive to a selection of an IP address input. The contextual actions menu 506-2 may include a dropdown list of various action categories 1106-1 of recommended actions 1104-1 to add an action block corresponding to the IP address input. The depicted example shows example investigative, generic, contain, and correction action categories 1106-1 from which the user may choose. Say the user selects the contain category from the dropdown list to add a containment action. Responsive to that contain category selection, a dropdown list of relevant and recommended actions 1104-1 for that action category may be exposed. The depicted example shows example relevant actions including allow IP, block IP, etc., with further options to drill down and select more specific actions. Say the user selects a block IP relevant action. Responsive to that block IP action selection, an action block corresponding to that block IP action may be added to the playbook canvas 302 automatically downstream of the geolocation IP action block, in a configured state in a manner similar to how the geolocate IP action block was added, to further build the playback.

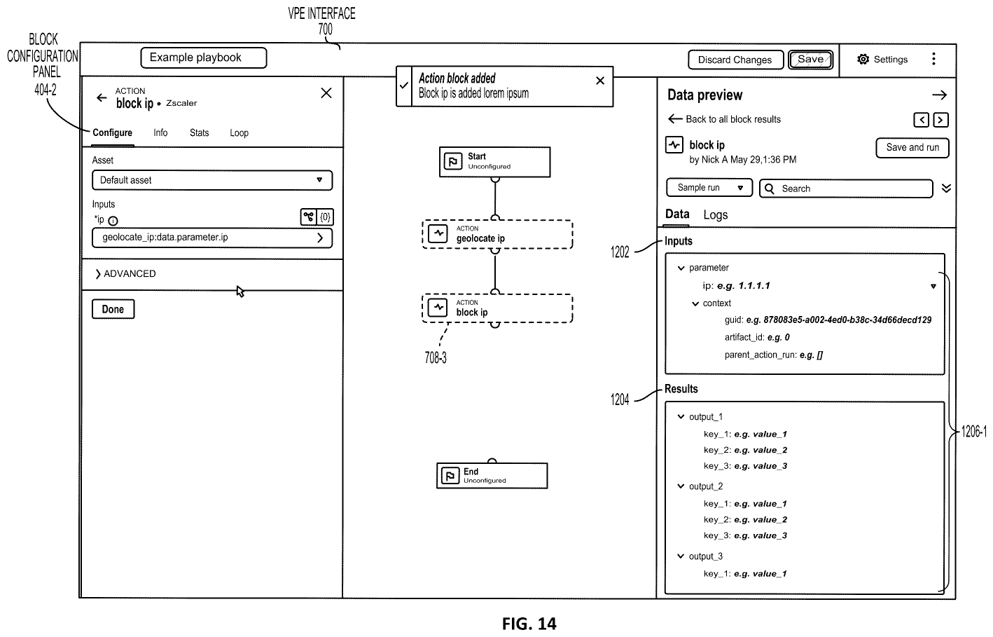

FIG. 14 illustrates an example portion of the VPE interface 700 after the block IP action block 708-3 has been added according to some examples. As before with respect to the geolocation IP action block 708-2, when the block IP action block 708-3 is added, the configuration panel 404-2 and the data preview panel 702 have been updated showing the inputs 1202 and results 1204 with sample data 1206-1 for outputs of the block IP action block 708-3. The above-described process may continue, including running, saving, and presenting real data, with respect to the block IP action block 708-3.

Referring again to FIG. 13, another feature of the data preview panel 702 may be providing the ability for a user to select between different runs of the playbook and/or portions thereof after a plurality of runs have been executed. The data preview panel 702 may include a selectable dropdown run list 1302 of the various runs that have been executed with the playbook. The dropdown run list 1302 may present a selectable chronicle of runs in sequential order according to the order in which the runs were executed. Accordingly, a user may select different runs from the dropdown run list 1302 to transition back and forth between runs so that the data preview panel 702 may present the inputs, results, sample data, real data, etc. for the different runs, with the function blocks 708 on the playbook canvas 302 also changing to the various states of the runs. When the user selects a particular function block 708 of a particular run, the data preview panel 702 may present the inputs, outputs, and results for that particular function block 708, allowing the user to easily drill down into each action. The user may see how the runs changed between iterations and may make changes to the various runs to test variations.

Entities of various types, such as companies, educational institutions, medical facilities, governmental departments, and private individuals, among other examples, operate computing environments for various purposes. Computing environments, which may also be referred to as information technology environments, may include inter-networked, physical hardware devices, the software executing on the hardware devices, and the users of the hardware and software. As an example, an entity such as a school may operate a Local Area Network (LAN) that includes desktop computers, laptop computers, smart phones, and tablets connected to a physical and wireless network, where users correspond to teachers and students. In this example, the physical devices may be in buildings or a campus that is controlled by the school. As another example, an entity such as a business may operate a Wide Area Network (WAN) that includes physical devices in multiple geographic locations where the offices of the business are located. In this example, the different offices may be inter-networked using a combination of public networks such as the Internet and private networks. As another example, an entity may operate a data center: a centralized location where computing resources are kept and maintained, and whose resources are accessible over a network. In this example, users associated with the entity that operates the data center may access the computing resources in the data center over public and/or private networks that may not be operated and controlled by the same entity. Alternatively or additionally, the operator of the data center may provide the computing resources to users associated with other entities, for example on a subscription basis. In both of these examples, users may expect resources to be available on demand and without direct active management by the user, a resource delivery model often referred to as cloud computing.

Entities that operate computing environments need information about their computing environments. For example, an entity may need to know the operating status of the various computing resources in the entity's computing environment, so that the entity may administer the environment, including performing configuration and maintenance, performing repairs or replacements, provisioning additional resources, removing unused resources, or addressing issues that may arise during operation of the computing environment, among other examples. As another example, an entity may use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and information about the computing environment may aid the entity in understanding whether the computing environment is serving its purpose well.

A data intake and query system may ingest and store data obtained from the components in a computing environment, and may enable an entity to search, analyze, and visualize the data. Through these and other capabilities, the data intake and query system may enable an entity to use the data for administration of the computing environment, to detect security issues, to understand how the computing environment is performing or being used, and/or to perform other analytics.

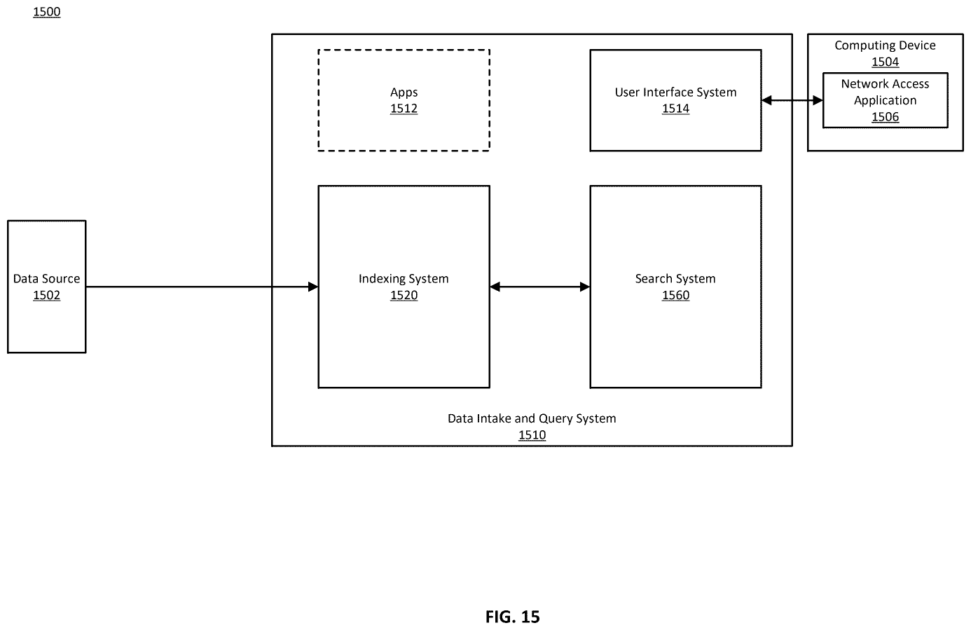

FIG. 15 is a block diagram illustrating an example computing environment 1500 that includes a data intake and query system 1510. The data intake and query system 1510 obtains data from a data source 1502 in the computing environment 1500 and ingests the data using an indexing system 1520. A search system 1560 of the data intake and query system 1510 enables users to navigate the indexed data. Though drawn with separate boxes, in some implementations the indexing system 1520 and the search system 1560 may have overlapping components. A computing device 1504, running a network access application 1506, may communicate with the data intake and query system 1510 through a user interface system 1514 of the data intake and query system 1510. Using the computing device 1504, a user may perform various operations with respect to the data intake and query system 1510, such as administration of the data intake and query system 1510, management and generation of “knowledge objects,” initiating of searches, and generation of reports, among other operations. The data intake and query system 1510 may further optionally include apps 1512 that extend the search, analytics, and/or visualization capabilities of the data intake and query system 1510.

The data intake and query system 1510 may be implemented using program code that may be executed using a computing device. A computing device is an electronic device that has a memory for storing program code instructions and a hardware processor for executing the instructions. The computing device may further include other physical components, such as a network interface or components for input and output. The program code for the data intake and query system 1510 may be stored on a non-transitory computer-readable medium, such as a magnetic or optical storage disk or a flash or solid-state memory, from which the program code may be loaded into the memory of the computing device for execution. “Non-transitory” means that the computer-readable medium may retain the program code while not under power, as opposed to volatile or “transitory” memory or media that requires power in order to retain data.

In various examples, the program code for the data intake and query system 1510 may execute on a single computing device, or may be distributed over multiple computing devices. For example, the program code may include instructions for executing both indexing and search components (which may be part of the indexing system 1520 and/or the search system 1560, respectively), and may be executed on a computing device that also provides the data source 1502. As another example, the program code may execute on one computing device, where the program code executes both indexing and search components, while another copy of the program code executes on a second computing device that provides the data source 1502. As another example, the program code may execute only an indexing component or only a search component. In this example, a first instance of the program code that is executing the indexing component and a second instance of the program code that is executing the search component may be executing on the same computing device or on different computing devices.

The data source 1502 of the computing environment 1500 is a component of a computing device that produces machine data. The component may be a hardware component (e.g., a microprocessor or a network adapter, among other examples) or a software component (e.g., a part of the operating system or an application, among other examples). The component may be a virtual component, such as a virtual machine, a virtual machine monitor (also referred as a hypervisor), a container, or a container orchestrator, among other examples. Examples of computing devices that may provide the data source 1502 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity may include, for example, operation status, actions performed, performance metrics, communications with other components, or communications with users, among other examples. The component may produce machine data in an automated fashion (e.g., through the ordinary course of being powered on and/or executing) and/or as a result of user interaction with the computing device (e.g., through the user's use of input/output devices or applications). The machine data may be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, the indexing system 1520 obtains machine date from the data source 1502 and processes and stores the data. Processing and storing of data may be referred to as “ingestion” of the data. Processing of the data may include parsing the data to identify individual events, where an event is a discrete portion of machine data that may be associated with a timestamp. Processing of the data may further include generating an index of the events, where the index is a data storage structure in which the events are stored. The indexing system 1520 does not require prior knowledge of the structure of incoming data (e.g., the indexing system 1520 does not need to be provided with a schema describing the data). Additionally, the indexing system 1520 retains a copy of the data as it was received by the indexing system 1520 such that the original data is always available for searching (e.g., no data is discarded, though, in some examples, the indexing system 1520 may be configured to do so).

The search system 1560 searches the data stored by the indexing system 1520. As discussed in greater detail below, the search system 1560 enables users associated with the computing environment 1500 (and possibly also other users) to navigate the data, generate reports, and visualize results in “dashboards” output using a graphical interface. Using the facilities of the search system 1560, users may obtain insights about the data, such as retrieving events from an index, calculating metrics, searching for specific conditions within a rolling time window, identifying patterns in the data, and predicting future trends, among other examples. To achieve greater efficiency, the search system 1560 may apply map-reduce methods to parallelize searching of large volumes of data. Additionally, because the original data is available, the search system 1560 may apply a schema to the data at search time. This allows different structures to be applied to the same data, or for the structure to be modified if or when the content of the data changes. Application of a schema at search time may be referred to herein as a late-binding schema technique.

The user interface system 1514 provides mechanisms through which users associated with the computing environment 1500 (and possibly others) may interact with the data intake and query system 1510. These interactions may include configuration, administration, and management of the indexing system 1520, initiation and/or scheduling of queries to the search system 1560, receipt or reporting of search results, and/or visualization of search results. The user interface system 1514 may include, for example, facilities to provide a command line interface or a web-based interface.

Users may access the user interface system 1514 using a computing device 1504 that communicates with data intake and query system 1510, possibly over a network. A “user,” in the context of the implementations and examples described herein, is a digital entity that is described by a set of information in a computing environment. The set of information may include, for example, a user identifier, a username, a password, a user account, a set of authentication credentials, a token, other data, and/or a combination of the preceding. Using the digital entity that is represented by a user, a person may interact with the computing environment 1500. For example, a person may log in as a particular user and, using the user's digital information, may access the data intake and query system 1510. A user may be associated with one or more people, meaning that one or more people may be able to use the same user's digital information. For example, an administrative user account may be used by multiple people who have been given access to the administrative user account. Alternatively or additionally, a user may be associated with another digital entity, such as a bot (e.g., a software program that may perform autonomous tasks). A user may also be associated with one or more entities. For example, a company may have associated with it a number of users. In this example, the company may control the users' digital information, including assignment of user identifiers, management of security credentials, control of which persons are associated with which users, and so on.

The computing device 1504 may provide a human-machine interface through which a person may have a digital presence in the computing environment 1500 in the form of a user. The computing device 1504 is an electronic device having one or more processors and a memory capable of storing instructions for execution by the one or more processors. The computing device 1504 may further include input/output (I/O) hardware and a network interface. Applications executed by the computing device 1504 may include a network access application 1506, which may a network interface of the client computing device 1504 to communicate, over a network, with the user interface system 1514 of the data intake and query system 1510. The user interface system 1514 may use the network access application 1506 to generate user interfaces that enable a user to interact with the data intake and query system 1510. A web browser is one example of a network access application. A shell tool may also be used as a network access application. In some examples, the data intake and query system 1510 is an application executing on the computing device 1504. In such examples, the network access application 1506 may access the user interface system 1514 without needed to go over a network.

The data intake and query system 1510 may optionally include apps 1512. An app of the data intake and query system 1510 is a collection of configurations, knowledge objects (a user-defined entity that enriches the data in the data intake and query system 1510), views, and dashboards that may provide additional functionality, different techniques for searching the data, and/or additional insights into the data. The data intake and query system 1510 may execute multiple applications simultaneously. Example applications include an information technology service intelligence application, which may monitor and analyze the performance and behavior of the computing environment 1500, and an enterprise security application, which may include content and searches to assist security analysts in diagnosing and acting on anomalous or malicious behavior in the computing environment 1500.

Though FIG. 15 illustrates only one data source, in practical implementations, the computing environment 1500 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of the computing environment 1500, the data intake and query system 1510 executes on an on-prem computing device and obtains machine data from on-prem data sources. An on-prem implementation may also be referred to as an “enterprise” network, though the term “on-prem” refers primarily to physical locality of a network and who controls that location while the term “enterprise” may be used to refer to the network of a single entity. As such, an enterprise network could include cloud components.

“Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources may also be referred to as a tenant of the provider entity. Users associated with the subscriber entity access the cloud resources over a network, which may include the public Internet. In contrast to an on-prem implementation, a subscriber entity does not have physical control of the computing devices that are in the cloud, and has digital access to resources provided by the computing devices only to the extent that such access is enabled by the provider entity.

In some implementations, the computing environment 1500 may include on-prem and cloud-based computing resources, or only cloud-based resources. For example, an entity may have on-prem computing devices and a private cloud. In this example, the entity operates the data intake and query system 1510 and may choose to execute the data intake and query system 1510 on an on-prem computing device or in the cloud. In another example, a provider entity operates the data intake and query system 1510 in a public cloud and provides the functionality of the data intake and query system 1510 as a service, for example under a Software-as-a-Service (SaaS) model. In this example, the provider entity may provision a separate tenant (or possibly multiple tenants) in the public cloud network for each subscriber entity, where each tenant executes a separate and distinct instance of the data intake and query system 1510. In some implementations, the entity providing the data intake and query system 1510 is itself subscribing to the cloud services of a cloud service provider. As an example, a first entity provides computing resources under a public cloud service model, a second entity subscribes to the cloud services of the first provider entity and uses the cloud computing resources to operate the data intake and query system 1510, and a third entity may subscribe to the services of the second provider entity in order to use the functionality of the data intake and query system 1510. In this example, the data sources are associated with the third entity, users accessing the data intake and query system 1510 are associated with the third entity, and the analytics and insights provided by the data intake and query system 1510 are for purposes of the third entity's operations.

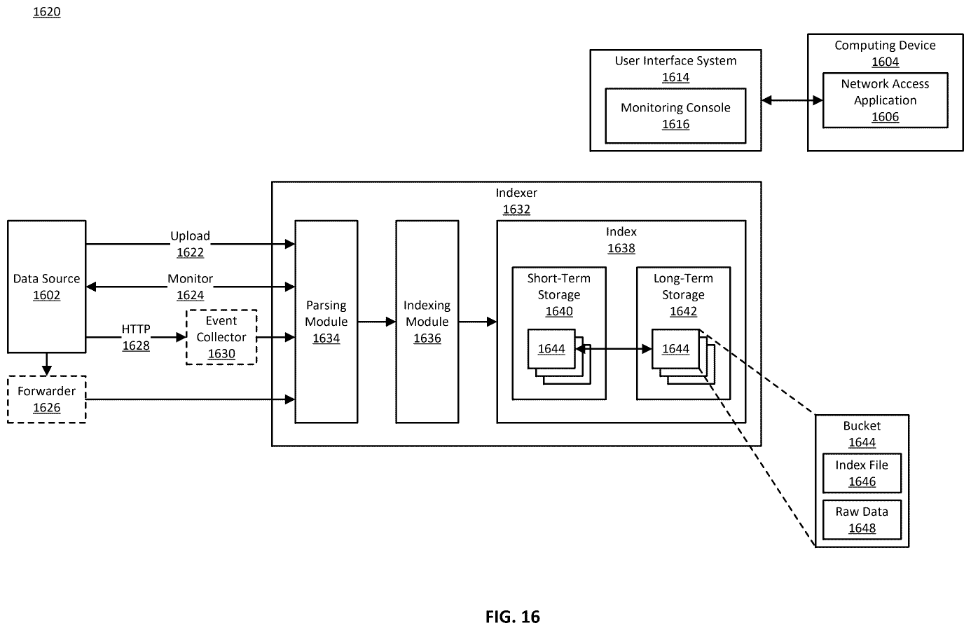

FIG. 16 is a block diagram illustrating in greater detail an example of an indexing system 1620 of a data intake and query system, such as the data intake and query system 1510 of FIG. 15. The indexing system 1620 of FIG. 16 uses various methods to obtain machine data from a data source 1602 and stores the data in an index 1638 of an indexer 1632. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. The indexing system 1620 enables the data intake and query system to obtain the machine data produced by the data source 1602 and to store the data for searching and retrieval.

Users may administer the operations of the indexing system 1620 using a computing device 1604 that may access the indexing system 1620 through a user interface system 1614 of the data intake and query system. For example, the computing device 1604 may be executing a network access application 1606, such as a web browser or a terminal, through which a user may access a monitoring console 1616 provided by the user interface system 1614. The monitoring console 1616 may enable operations such as: identifying the data source 1602 for indexing; configuring the indexer 1632 to index the data from the data source 1602; configuring a data ingestion method; configuring, deploying, and managing clusters of indexers; and viewing the topology and performance of a deployment of the data intake and query system, among other operations. The operations performed by the indexing system 1620 may be referred to as “index time” operations, which are distinct from “search time” operations that are discussed further below.

The indexer 1632, which may be referred to herein as a data indexing component, coordinates and performs most of the index time operations. The indexer 1632 may be implemented using program code that may be executed on a computing device. The program code for the indexer 1632 may be stored on a non-transitory computer-readable medium (e.g. a magnetic, optical, or solid state storage disk, a flash memory, or another type of non-transitory storage media), and from this medium may be loaded or copied to the memory of the computing device. One or more hardware processors of the computing device may read the program code from the memory and execute the program code in order to implement the operations of the indexer 1632. In some implementations, the indexer 1632 executes on the computing device 1604 through which a user may access the indexing system 1620. In some implementations, the indexer 1632 executes on a different computing device.

The indexer 1632 may be executing on the computing device that also provides the data source 1602 or may be executing on a different computing device. In implementations wherein the indexer 1632 is on the same computing device as the data source 1602, the data produced by the data source 1602 may be referred to as “local data.” In other implementations the data source 1602 is a component of a first computing device and the indexer 1632 executes on a second computing device that is different from the first computing device. In these implementations, the data produced by the data source 1602 may be referred to as “remote data.” In some implementations, the first computing device is “on-prem” and in some implementations the first computing device is “in the cloud.” In some implementations, the indexer 1632 executes on a computing device in the cloud and the operations of the indexer 1632 are provided as a service to entities that subscribe to the services provided by the data intake and query system.

For a given data produced by the data source 1602, the indexing system 1620 may be configured to use one of several methods to ingest the data into the indexer 1632. These methods include upload 1622, monitor 1624, using a forwarder 1626, or using HyperText Transfer Protocol (HTTP 1628) and an event collector 1630. These and other methods for data ingestion may be referred to as “getting data in” (GDI) methods.

Using the upload 1622 method, a user may instruct the indexing system to 1602 to specify a file for uploading into the indexer 1632. For example, the monitoring console 1616 may include commands or an interface through which the user may specify where the file is located (e.g., on which computing device and/or in which directory of a file system) and the name of the file. Once uploading is initiated, the indexer 1632 processes the file, as discussed further below. Uploading is a manual process and occurs when instigated by a user. For automated data ingestion, the other ingestion methods are used.

The monitor 1624 method enables the indexing system 1620 to monitor the data source 1602 and continuously or periodically obtain data produced by the data source 1602 for ingestion by the indexer 1632. For example, using the monitoring console 1616, a user may specify a file or directory for monitoring. In this example, the indexing system 1620 may execute a monitoring process that detects whenever data is added to the file or directory and causes the data to be sent to the indexer 1632. As another example, a user may specify a network port for monitoring. In this example, a monitoring process may capture data received at or transmitting from the network port and cause the data to be sent to the indexer 1632. In various examples, monitoring may also be configured for data sources such as operating system event logs, performance data generated by an operating system, operating system registries, operating system directory services, and other data sources.

Monitoring is available when the data source 1602 is local to the indexer 1632 (e.g., the data source 1602 is on the computing device where the indexer 1632 is executing). Other data ingestion methods, including forwarding and the event collector 1630, may be used for either local or remote data sources.

A forwarder 1626, which may be referred to herein as a data forwarding component, is a software process that sends data from the data source 1602 to the indexer 1632. The forwarder 1626 may be implemented using program code that may be executed on the computer device that provides the data source 1602. A user launches the program code for the forwarder 1626 on the computing device that provides the data source 1602. The user may further configure the program code, for example to specify a receiver for the data being forwarded (e.g., one or more indexers, another forwarder, and/or another recipient system), to enable or disable data forwarding, and to specify a file, directory, network events, operating system data, or other data to forward, among other operations.

The forwarder 1626 may provide various capabilities. For example, the forwarder 1626 may send the data unprocessed or may perform minimal processing on the data. Minimal processing may include, for example, adding metadata tags to the data to identify a source, source type, and/or host, among other information, dividing the data into blocks, and/or applying a timestamp to the data. In some implementations, the forwarder 1626 may break the data into individual events (event generation is discussed further below) and send the events to a receiver. Other operations that the forwarder 1626 may be configured to perform include buffering data, compressing data, and using secure protocols for sending the data, for example.

Forwarders may be configured in various topologies. For example, multiple forwarders may send data to the same indexer. As another example, a forwarder may be configured to filter and/or route events to specific receivers (e.g., different indexers), and/or discard events. As another example, a forwarder may be configured to send data to another forwarder, or to a receiver that is not an indexer or a forwarder (such as, for example, a log aggregator).

The event collector 1630 provides an alternate method for obtaining data from the data source 1602. The event collector 1630 enables data and application events to be sent to the indexer 1632 using HTTP 1628. The event collector 1630 may be implemented using program code that may be executing on a computing device. The program code may be a component of the data intake and query system or may be a standalone component that may be executed independently of the data intake and query system and operates in cooperation with the data intake and query system.

To use the event collector 1630, a user can, for example using the monitoring console 1616 or a similar interface provided by the user interface system 1614, enable the event collector 1630 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token may be used, for example, by the data source 1602 as an alternative method to using a username and password for authentication.

To send data to the event collector 1630, the data source 1602 is supplied with a token and may then send HTTP 1628 requests to the event collector 1630. To send HTTP 1628 requests, the data source 1602 may be configured to use an HTTP client and/or to use logging libraries such as those supplied by Java, JavaScript, and .NET libraries. An HTTP client enables the data source 1602 to send data to the event collector 1630 by supplying the data, and a Uniform Resource Identifier (URI) for the event collector 1630 to the HTTP client. The HTTP client then handles establishing a connection with the event collector 1630, transmitting a request containing the data, closing the connection, and receiving an acknowledgment if the event collector 1630 sends one. Logging libraries enable HTTP 1628 requests to the event collector 1630 to be generated directly by the data source. For example, an application may include or link a logging library, and through functionality provided by the logging library manage establishing a connection with the event collector 1630, transmitting a request, and receiving an acknowledgement.

An HTTP 1628 request to the event collector 1630 may contain a token, a channel identifier, event metadata, and/or event data. The token authenticates the request with the event collector 1630. The channel identifier, if available in the indexing system 1620, enables the event collector 1630 to segregate and keep separate data from different data sources. The event metadata may include one or more key-value pairs that describe the data source 1602 or the event data included in the request. For example, the event metadata may include key-value pairs specifying a timestamp, a hostname, a source, a source type, or an index where the event data should be indexed. The event data may be a structured data object, such as a JavaScript Object Notation (JSON) object, or raw text. The structured data object may include both event data and event metadata. Additionally, one request may include event data for one or more events.

In some implementations, the event collector 1630 extracts events from HTTP 1628 requests and sends the events to the indexer 1632. The event collector 1630 may further be configured to send events or event data to one or more indexers. Extracting the events may include associating any metadata in a request with the event or events included in the request. In these implementations, event generation by the indexer 1632 (discussed further below) is bypassed, and the indexer 1632 moves the events directly to indexing. In some implementations, the event collector 1630 extracts event data from a request and outputs the event data to the indexer 1632, and the indexer generates events from the event data. In some implementations, the event collector 1630 sends an acknowledgement message to the data source 1602 to indicate that the event collector 1630 has received a particular request form the data source 1602, and/or to indicate to the data source 1602 that events in the request have been added to an index.

The indexer 1632 ingests incoming data and transforms the data into searchable knowledge in the form of events. In the data intake and query system, an event is a single piece of data that represents activity of the component represented in FIG. 16 by the data source 1602. An event may be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key may be inferred or assumed.

Transformation of data into events may include event generation and event indexing. Event generation includes identifying each discrete piece of data that represents one event and associating each event with a timestamp and possibly other information (which may be referred to herein as metadata). Event indexing includes storing of each event in the data structure of an index. As an example, the indexer 1632 may include a parsing module 1634 and an indexing module 1636 for generating and storing the events. The parsing module 1634 and indexing module 1636 may be modular and pipelined, such that one component may be operating on a first set of data while the second component is simultaneously operating on a second sent of data. Additionally, the indexer 1632 may at any time have multiple instances of the parsing module 1634 and indexing module 1636, with each set of instances configured to simultaneously operate on data from the same data source or from different data sources. The parsing module 1634 and indexing module 1636 are illustrated to facilitate discussion, with the understanding that implementations with other components are possible to achieve the same functionality.

The parsing module 1634 determines information about event data, where the information may be used to identify events within the event data. For example, the parsing module 1634 may associate a source type with the event data. A source type identifies the data source 1602 and describes a possible data structure of event data produced by the data source 1602. For example, the source type may indicate which fields to expect in events generated at the data source 1602 and the keys for the values in the fields, and possibly other information such as sizes of fields, an order of the fields, a field separator, and so on. The source type of the data source 1602 may be specified when the data source 1602 is configured as a source of event data. Alternatively, the parsing module 1634 may determine the source type from the event data, for example from an event field or using machine learning.

Other information that the parsing module 1634 may determine includes timestamps. In some cases, an event includes a timestamp as a field, and the timestamp indicates a point in time when the action represented by the event occurred or was recorded by the data source 1602 as event data. In these cases, the parsing module 1634 may be able to determine from the source type associated with the event data that the timestamps may be extracted from the events themselves. In some cases, an event does not include a timestamp and the parsing module 1634 determines a timestamp for the event, for example from a name associated with the event data from the data source 1602 (e.g., a file name when the event data is in the form of a file) or a time associated with the event data (e.g., a file modification time). As another example, when the parsing module 1634 is not able to determine a timestamp from the event data, the parsing module 1634 may use the time at which it is indexing the event data. As another example, the parsing module 1634 may use a user-configured rule to determine the timestamps to associate with events.

The parsing module 1634 may further determine event boundaries. In some cases, a single line (e.g., a sequence of characters ending with a line termination) in event data represents one event while in other cases, a single line represents multiple events. In yet other cases, one event may span multiple lines within the event data. The parsing module 1634 may be able to determine event boundaries from the source type associated with the event data, for example from a data structure indicated by the source type. In some implementations, a user may configure rules the parsing module 1634 may use to identify event boundaries.

The parsing module 1634 may further extract data from events and possibly also perform transformations on the events. For example, the parsing module 1634 may extract a set of fields for each event, such as a host or hostname, source or source name, and/or source type. The parsing module 1634 may extract certain fields by default or based on a user configuration. Alternatively or additionally, the parsing module 1634 may add fields to events, such as a source type or a user-configured field. As another example of a transformation, the parsing module 1634 may anonymize fields in events to mask sensitive information, such as social security numbers or account numbers. Anonymizing fields may include changing or replacing values of specific fields. The parsing component 1634 may further perform user-configured transformations.

The parsing module 1634 outputs the results of processing incoming event data to the indexing module 1636, which performs event segmentation and builds index data structures.

Event segmentation identifies searchable segments, which may alternatively be referred to as searchable terms or keywords, which may be used by the search system of the data intake and query system to search the event data. A searchable segment may be a part of a field in an event or an entire field. The indexer 1632 may be configured to identify searchable segments that are parts of fields, searchable segments that are entire fields, or both. The parsing module 1634 organizes the searchable segments into a lexicon or dictionary for the event data, with the lexicon including each searchable segment and a reference to the location of each occurrence of the searchable segment within the event data. As discussed further below, the search system may use the lexicon, which is stored in an index file 1646, to find event data that matches a search query. In some implementations, segmentation may alternatively be performed by the forwarder 1626. Segmentation may also be disabled, in which case the indexer 1632 will not build a lexicon for the event data. When segmentation is disabled, the search system searches the event data directly.

Building index data structures generates the index 1638. The index 1638 is a storage data structure on a storage device (e.g., a disk drive or other physical device for storing digital data). The storage device may be a component of the computing device on which the indexer 1632 is operating (referred to herein as local storage) or may be a component of a different computing device (referred to herein as remote storage) that the indexer 1638 has access to over a network. The indexer 1632 may include more than one index and may include indexes of different types. For example, the indexer 1632 may include event indexes, which impose minimal structure on stored data and may accommodate any type of data. As another example, the indexer 1632 may include metrics indexes, which use a highly structured format to handle the higher volume and lower latency demands associated with metrics data.

The indexing module 1636 organizes files in the index 1638 in directories referred to as buckets. The files in a bucket 1644 may include raw data files, index files, and possibly also other metadata files. As used herein, “raw data” means data as when the data was produced by the data source 1602, without alteration to the format or content. As noted previously, the parsing component 1634 may add fields to event data and/or perform transformations on fields in the event data, and thus a raw data file 1648 may include, in addition to or instead of raw data, what is referred to herein as enriched raw data. The raw data file 1648 may be compressed to reduce disk usage. An index file 1646, which may also be referred to herein as a “time-series index” or tsidx file, contains metadata that the indexer 1632 may use to search a corresponding raw data file 1648. As noted above, the metadata in the index file 1646 includes a lexicon of the event data, which associates each unique keyword in the event data in the raw data file 1648 with a reference to the location of event data within the raw data file 1648. The keyword data in the index file 1646 may also be referred to as an inverted index. In various implementations, the data intake and query system may use index files for other purposes, such as to store data summarizations that may be used to accelerate searches.

A bucket 1644 includes event data for a particular range of time. The indexing module 1636 arranges buckets in the index 1638 according to the age of the buckets, such that buckets for more recent ranges of time are stored in short-term storage 1640 and buckets for less recent ranges of time are stored in long-term storage 1642. Short-term storage 1640 may be faster to access while long-term storage 1642 may be slower to access. Buckets may move from short-term storage 1640 to long-term storage 1642 according to a configurable data retention policy, which may indicate at what point in time a bucket is old enough to be moved.

A bucket's location in short-term storage 1640 or long-term storage 1642 may also be indicated by the bucket's status. As an example, a bucket's status may be “hot,” “warm,” “cold,” “frozen,” or “thawed.” In this example, hot bucket is one to which the indexer 1632 is writing data and the bucket becomes a warm bucket when the index 1632 stops writing data to it. In this example, both hot and warm buckets reside in short-term storage 1640. Continuing this example, when a warm bucket is moved to long-term storage 1642, the bucket becomes a cold bucket. A cold bucket may become a frozen bucket after a period of time, at which point the bucket may be deleted or archived. An archived bucket cannot be searched. When an archived bucket is retrieved for searching, the bucket becomes thawed and may then be searched.

The indexing system 1620 may include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket may configured (e.g., three copies of each buckets must exist within the cluster), and indexers to which buckets are copied may be selected to optimize distribution of data across the cluster.

A user may view the performance of the indexing system 1620 through the monitoring console 1616 provided by the user interface system 1614. Using the monitoring console 1616, the user may configure and monitor an index cluster, and see information such as disk usage by an index, volume usage by an indexer, index and volume size over time, data age, statistics for bucket types, and bucket settings, among other information.

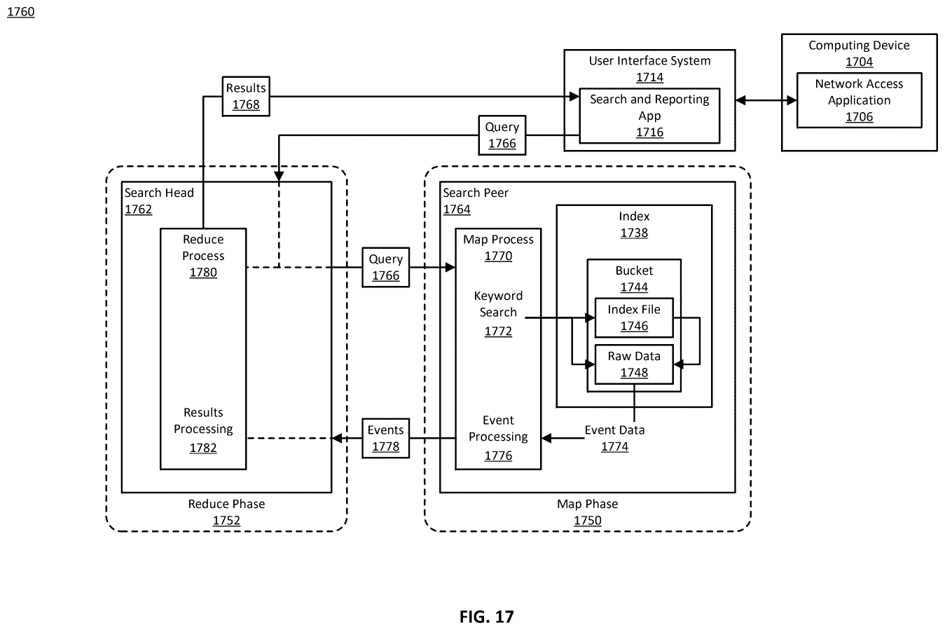

FIG. 17 is a block diagram illustrating in greater detail an example of the search system 1760 of a data intake and query system, such as the data intake and query system 1510 of FIG. 15. The search system 1760 of FIG. 17 issues a query 1766 to a search head 1762, which sends the query 1766 to a search peer 1764. Using a map process 1770, the search peer 1764 searches the appropriate index 1738 for events identified by the query 1766 and sends events 1778 so identified back to the search head 1762. Using a reduce process 1782, the search head 1762 processes the events 1778 and produces results 1768 to respond to the query 1766. The results 1768 may provide useful insights about the data stored in the index 1738. These insights may aid in the administration of information technology systems, in security analysis of information technology systems, and/or in analysis of the development environment provided by information technology systems.

The query 1766 that initiates a search is produced by a search and reporting app 1716 that is available through the user interface system 1714 of the data intake and query system. Using a network access application 1706 executing on a computing device 1704, a user may input the query 1766 into a search field provided by the search and reporting app 1716. Alternatively or additionally, the search and reporting app 1716 may include pre-configured queries or stored queries that may be activated by the user. In some cases, the search and reporting app 1716 initiates the query 1766 when the user enters the query 1766. In these cases, the query 1766 maybe referred to as an “ad-hoc” query. In some cases, the search and reporting app 1716 initiates the query 1766 based on a schedule. For example, the search and reporting app 1716 may be configured to execute the query 1766 once per hour, once per day, at a specific time, on a specific date, or at some other time that may be specified by a date, time, and/or frequency. These types of queries maybe referred to as scheduled queries.

The query 1766 is specified using a search processing language. The search processing language includes commands that the search peer 1764 will use to identify events to return in the search results 1768. The search processing language may further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable the query 1766 to include sequential commands, where a subsequent command may operate on the results of a prior command. As an example, sequential commands may be separated in the query 1766 by a vertical line (“|” or “pipe”) symbol.

In addition to one or more search commands, the query 1766 includes a time indicator. The time indicator limits searching to events that have timestamps described by the indicator. For example, the time indicator may indicate a specific point in time (e.g., 10:00:00 am today), in which case only events that have the point in time for their timestamp will be searched. As another example, the time indicator may indicate a range of time (e.g., the last 24 hours), in which case only events whose timestamps fall within the range of time will be searched. The time indicator may alternatively indicate all of time, in which case all events will be searched.

Processing of the search query 1766 occurs in two broad phases: a map phase 1750 and a reduce phase 1752. The map phase 1750 takes place across one or more search peers. In the map phase 1750, the search peers locate event data that matches the search terms in the search query 1766 and sorts the event data into field-value pairs. When the map phase 1750 is complete, the search peers send events that they have found to one or more search heads for the reduce phase 1752. During the reduce phase 1752, the search heads process the events through commands in the search query 1766 and aggregate the events to produce the final search results 1768.

A search head, such as the search head 1762 illustrated in FIG. 17, is a component of the search system 1760 that manages searches. The search head 1762, which may also be referred to herein as a search management component, may be implemented using program code that may be executed on a computing device. The program code for the search head 1762 may be stored on a non-transitory computer-readable medium and from this medium may be loaded or copied to the memory of a computing device. One or more hardware processors of the computing device may read the program code from the memory and execute the program code in order to implement the operations of the search head 1762.

Upon receiving the search query 1766, the search head 1762 directs the query 1766 to one or more search peers, such as the search peer 1764 illustrated in FIG. 17. “Search peer” is an alternate name for “indexer” and a search peer may be largely similar to the indexer described previously. The search peer 1764 may be referred to as a “peer node” when the search peer 1764 is part of an indexer cluster. The search peer 1764, which may also be referred to as a search execution component, may be implemented using program code that may be executed on a computing device. In some implementations, one set of program code implements both the search head 1762 and the search peer 1764 such that the search head 1762 and the search peer 1764 form one component. In some implementations, the search head 1762 is an independent piece of code that performs searching and no indexing functionality. In these implementations, the search head 1762 may be referred to as a dedicated search head.

The search head 1762 may consider multiple criteria when determining whether to send the query 1766 to the particular search peer 1764. For example, the search system 1760 may be configured to include multiple search peers that each have duplicative copies of at least some of the event data. In this example, the sending the search query 1766 to more than one search peer allows the search system 1760 to distribute the search workload across different hardware resources. As another example, search system 1760 may include different search peers for different purposes (e.g., one has an index storing a first type of data or from a first data source while a second has an index storing a second type of data or from a second data source). In this example, the search query 1766 may specify which indexes to search, and the search head 1762 will send the query 1766 to the search peers that have those indexes.

To identify events 1778 to send back to the search head 1762, the search peer 1764 performs a map process 1770 to obtain event data 1774 from the index 1738 that is maintained by the search peer 1764. During a first phase of the map process 1770, the search peer 1764 identifies buckets that have events that are described by the time indicator in the search query 1766. As noted above, a bucket contains events whose timestamps fall within a particular range of time. For each bucket 1744 whose events may be described by the time indicator, during a second phase of the map process 1770, the search peer 1764 performs a keyword search 1772 using search terms specified in the search query 1766. The search terms may be one or more of keywords, phrases, fields, Boolean expressions, and/or comparison expressions that in combination describe events being searched for. When segmentation is enabled at index time, the search peer 1764 performs the keyword search 1772 on the bucket's index file 1746. As noted previously, the index file 1746 includes a lexicon of the searchable terms in the events stored in the bucket's raw data 1748 file. The keyword search 1772 searches the lexicon for searchable terms that correspond to one or more of the search terms in the query 1766. As also noted above, the lexicon incudes, for each searchable term, a reference to each location in the raw data 1748 file where the searchable term may be found. Thus, when the keyword search identifies a searchable term in the index file 1746 that matches query 1766, the search peer 1764 may use the location references to extract from the raw data 1748 file the event data 1774 for each event that include the searchable term.

In cases where segmentation was disabled at index time, the search peer 1764 performs the keyword search 1772 directly on the raw data 1748 file. To search the raw data 1748, the search peer 1764 may identify searchable segments in events in a similar manner as when the data was indexed. Thus, depending on how the search peer 1764 is configured, the search peer 1764 may look at event fields and/or parts of event fields to determine whether an event matches the query 1766. Any matching events may be added to the event data 1774 read from the raw data 1748 file. The search peer 1764 may further be configured to enable segmentation at search time, so that searching of the index 1738 causes the search peer 1764 to build a lexicon in the index file 1746.

The event data 1774 obtained from the raw data 1748 file includes the full text of each event found by the keyword search 1772. During a third phase of the map process 1770, the search peer 1764 performs event processing 1776 on the event data 1774, with the steps performed being determined by the configuration of the search peer 1764 and/or commands in the search query 1766. For example, the search peer 1764 may be configured to perform field discovery and field extraction. Field discovery is a process by which the search peer 1764 identifies and extracts key-value pairs from the events in the event data 1774. The search peer 1764 can, for example, be configured to automatically extract the first 100 fields (or another number of fields) in the event data 1774 that may be identified as key-value pairs. As another example, the search peer 1764 may extract any fields explicitly mentioned in the search query 1766. The search peer 1764 can, alternatively or additionally, be configured with particular field extractions to perform.

Other examples of steps that may be performed during event processing 1776 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

The search peer 1764 sends processed events 1778 to the search head 1762, which performs a reduce process 1780. The reduce process 1780 potentially receives events from multiple search peers and performs various results processing 1782 steps on the events. The results processing 1782 steps may include, for example, aggregating the events from different search peers into a single set of events, deduplicating and aggregating fields discovered by different search peers, counting the number of events found, and sorting the events by timestamp (e.g., newest first or oldest first), among other examples. Results processing 1782 may further include applying commands from the search query 1766 to the events. The query 1766 may include, for example, commands for evaluating and/or manipulating fields (e.g., to generate new fields from existing fields or parse fields that have more than one value). As another example, the query 1766 may include commands for calculating statistics over the events, such as counts of the occurrences of fields, or sums, averages, ranges, and so on, of field values. As another example, the query 1766 may include commands for generating statistical values for purposes of generating charts of graphs of the events.

Through results processing 1782, the reduce process 1780 produces the events found by processing the search query 1766, as well as some information about the events, which the search head 1762 outputs to the search and reporting app 1716 as search results 1768. The search and reporting app 1716 may generate visual interfaces for viewing the search results 1768. The search and reporting app 1716 can, for example, output visual interfaces for the network access application 1706 running on a computing device 1704 to generate.

The visual interfaces may include various visualizations of the search results 1768, such as tables, line or area charts, Chloropleth maps, or single values. The search and reporting app 1716 may organize the visualizations into a dashboard, where the dashboard includes a panel for each visualization. A dashboard may thus include, for example, a panel listing the raw event data for the events in the search results 1768, a panel listing fields extracted at index time and/or found through field discovery along with statistics for those fields, and/or a timeline chart indicating how many events occurred at specific points in time (as indicated by the timestamps associated with each event). In various implementations, the search and reporting app 1716 may provide one or more default dashboards. Alternatively or additionally, the search and reporting app 1716 may include functionality that enables a user to configure custom dashboards.

The search and reporting app 1716 may also enable further investigation into the events in the search results 1768. The process of further investigation may be referred to as drilldown. For example, a visualization in a dashboard may include interactive elements, which, when selected, provide options for finding out more about the data being displayed by the interactive elements. To find out more, an interactive element can, for example, generate a new search that includes some of the data being displayed by the interactive element, and thus may be more focused than the initial search query 1766. As another example, an interactive element may launch a different dashboard whose panels include more detailed information about the data that is displayed by the interactive element. Other examples of actions that may be performed by interactive elements in a dashboard include opening a link, playing an audio or video file, or launching another application, among other examples.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above may be combined with each other, except to the extent it may be otherwise stated above or to the extent that any such examples may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective examples may be combined in any manner.

Processing of the various components of systems illustrated herein may be distributed across multiple machines, networks, and other computing resources. Two or more components of a system may be combined into fewer components. Various components of the illustrated systems may be implemented in one or more virtual machines or an isolated execution environment, rather than in dedicated computer hardware systems and/or computing devices. Likewise, the data repositories shown may represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown may communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that may direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In some examples, certain operations, acts, events, or functions of any of the algorithms described herein may be performed in a different sequence, may be added, merged, or left out altogether (e.g., not all are necessary for the practice of the algorithms). In certain examples, operations, acts, functions, or events may be performed concurrently, e.g., through multi-threaded processing, interrupt processing, or multiple processors or processor cores or on other parallel architectures, rather than sequentially.

What is claimed:

1. A computer-implemented method comprising:
sending, by an information technology (IT) and security operations application executing in a cloud provider network, resources to facilitate presentation of a graphical user interface (GUI) that allows configuring of function blocks with a playbook editor to build a playbook, wherein the playbook editor comprises an interface, and the interface comprises a playbook canvas that allows addition and interrelation of function blocks to define an ordered set of operations to be performed in response to identification of an incident in an IT environment associated with a user;
receiving a selection of an interface option to add a first function block to the playbook canvas;
responsive to the selection, adding the first function block to the playbook canvas of the interface; and
causing presentation, via the interface, of outputs of the first function block with sample data for the outputs in a data panel of the interface, wherein the data panel is presented in conjunction with the playbook canvas.

2. The computer-implemented method as recited in claim 1, further comprising:
executing the first function block with respect to the incident; and
consequent to the execution, updating, and causing presentation of, the data panel with actual data associated with the incident and produced from the execution of the first function block.

3. The computer-implemented method as recited in claim 1, wherein the data panel presents a flow of the outputs of the first function block associated with the sample data as the playbook is being built.

4. The computer-implemented method as recited in claim 1, further comprising:
generating, as a function of a particular state of the data panel, one or more recommended actions as one or more candidates to be included within a second function block for the playbook; and
presenting, via the interface, the one or more recommended actions.

5. The computer-implemented method as recited in claim 4, further comprising:
receiving a selection of a particular recommended action from the one or more recommended actions; and
responsive to the selection of the particular recommended action, adding the second function block corresponding to the particular recommended action to the playbook canvas.

6. The computer-implemented method as recited in claim 5, wherein the adding the second function block comprises connecting the second function block with a connector to the first function block.

7. The computer-implemented method as recited in claim 6, wherein the second function block is added in a configured state with a corresponding field within the second function block prepopulated with corresponding data path from the first function block.

8. A system comprising:
one or more processing devices to implement an information technology (IT) and security operations application executing in a cloud provider network and cause the system to perform operations comprising:
sending resources to facilitate presentation of a graphical user interface (GUI) that allows configuring of function blocks with a playbook editor to build a playbook, wherein the playbook editor comprises an interface, and the interface comprises a playbook canvas that allows addition and interrelation of function blocks to define an ordered set of operations to be performed in response to identification of an incident in an IT environment associated with a user;
receiving a selection of an interface option to add a first function block to the playbook canvas;
responsive to the selection, adding the first function block to the playbook canvas of the interface; and
causing presentation, via the interface, of outputs of the first function block with sample data for the outputs in a data panel of the interface, wherein the data panel is presented in conjunction with the playbook canvas.

9. The system as recited in claim 8, the operations further comprising:
executing the first function block with respect to the incident; and
consequent to the execution, updating, and causing presentation of, the data panel with actual data associated with the incident and produced from the execution of the first function block.

10. The system as recited in claim 8, wherein the data panel presents a flow of the outputs of the first function block associated with the sample data as the playbook is being built.

11. The system as recited in claim 8, the operations further comprising:
generating, as a function of a particular state of the data panel, one or more recommended actions as one or more candidates to be included within a second function block for the playbook; and
presenting, via the interface, the one or more recommended actions.

12. The system as recited in claim 11, the operations further comprising:
receiving a selection of a particular recommended action from the one or more recommended actions; and
responsive to the selection of the particular recommended action, adding the second function block corresponding to the particular recommended action to the playbook canvas.

13. The system as recited in claim 12, wherein the adding the second function block comprises connecting the second function block with a connector to the first function block.

14. The system as recited in claim 13, wherein the second function block is added in a configured state with a corresponding field within the second function block prepopulated with corresponding data path from the first function block.

15. One or more non-transitory, computer-readable media having stored thereon instructions which, when executed by one or more processors, cause a system in a cloud provider network to perform operations comprising:
sending resources to facilitate presentation of a graphical user interface (GUI) that allows configuring of function blocks with a playbook editor to build a playbook, wherein the playbook editor comprises an interface, and the interface comprises a playbook canvas that allows addition and interrelation of function blocks to define an ordered set of operations to be performed in response to identification of an incident in an information technology (IT) environment associated with a user;
receiving a selection of an interface option to add a first function block to the playbook canvas;
responsive to the selection, adding the first function block to the playbook canvas of the interface; and
causing presentation, via the interface, of outputs of the first function block with sample data for the outputs in a data panel of the interface, wherein the data panel is presented in conjunction with the playbook canvas.

16. The one or more non-transitory, computer-readable media as recited in claim 15, the operations further comprising:
executing the first function block with respect to the incident; and
consequent to the execution, updating, and causing presentation of, the data panel with actual data associated with the incident and produced from the execution of the first function block.

17. The one or more non-transitory, computer-readable media as recited in claim 15, wherein the data panel presents a flow of the outputs of the first function block associated with the sample data as the playbook is being built.

18. The one or more non-transitory, computer-readable media as recited in claim 15, the operations further comprising:
generating, as a function of a particular state of the data panel, one or more recommended actions as one or more candidates to be included within a second function block for the playbook; and
presenting, via the interface, the one or more recommended actions.

19. The one or more non-transitory, computer-readable media as recited in claim 18, the operations further comprising:
receiving a selection of a particular recommended action from the one or more recommended actions; and
responsive to the selection of the particular recommended action, adding the second function block corresponding to the particular recommended action to the playbook canvas.

20. The one or more non-transitory, computer-readable media as recited in claim 19, wherein the adding the second function block comprises connecting the second function block with a connector to the first function block.
